(19) United States
(12) Patent Application Publication
(10) Pub. No.: US 2021/0130144 A1
(43) Pub. Date: May 6, 2021

(54) Winch and Level Wind

(71) Applicant: Woods Hole Oceanographic Institution, Woods Hole, MA (US)

(72) Inventors: James A. Haley, Woods Hole, MA (US); Joshua A. Eaton, Woods Hole, MA (US)

(73) Assignee: Woods Hole Oceanographic Institution, Woods Hole, MA (US)

(21) Appl. No.: 17/145,902

(22) Filed: Jan. 11, 2021

Related U.S. Application Data
(63) Continuation-in-part of application No. 15/747,611, filed on Jan. 25, 2018, now Pat. No. 10,889,475.
(60) Provisional application No. 62/201,133, filed on Aug. 5, 2015.

(51) Int. Cl. B66D 1/38; B66D 1/14; B66D 1/12; B66D 1/52

(52) U.S. Cl. CPC B66D 1/38; B66D 1/52; B66D 1/12; B66D 1/14

(57) ABSTRACT

A lightweight winch has the motor assembly centered with a housing within the winch drum where it may be easily accessed and removed from the winch drum. The winch comprises an improved, non-load bearing level wind mechanism for evenly winding cable about the winch drum. And a small-footprint level wind system having elongate support, a leadscrew, a guide substantially supported by the support, the guide adapted to accept a tension member. The guide designed to move along the support and to transfer tension member forces onto the support. Further comprising a motor, adapted to apply a motive onto the leadscrew, a shuttle connected the guide and leadscrew and adapted to transfer the motive force to the guide, moving the guide along the support. Also provides direct tension member metering and load sensing within the guide, and a load-bearing leadscrew having a direct connection between guide and leadscrew.

### CROSS REFERENCE TO RELATED APPLICATIONS

This is a continuation-in-part (CIP) application that claims priority to and the benefit of U.S. application Ser. No. 15/747,611, entitled Compact Winch, filed on Aug. 5, 2015, now U.S. Pat. No. 10,889,475 issued on Jan. 12, 2021 and U.S. Provisional Patent Application No. 62/201,133. This application incorporates by reference the U.S. patent application Ser. No. 14/963,570, filed on Dec. 9, 2015, the contents of which are hereby incorporated as if set forth herein in its entirety.

### FIELD OF THE INVENTION

The present invention describes a compact winch with a motor and gear assembly disposed within the winch drum, reducing the size and clearance profile of the winch while providing a high strength hauling capacity. As well as a compact, simplified, single support level wind system for winch assemblies,

### BACKGROUND OF THE INVENTION

Winches are most often used in commercial and research operations for the hauling, retrieval, or otherwise adjustment of cable tension of heavy loads both on land and in marine environments. Generally, the basic elements of a winch system include a wide spool or winch drum mounted by a frame and rotated by a motor assembly or drive mechanism. The motor assembly connects to the winch drum to drive rotation to reel in or reel out cable wound around the winch drum.

Moreover, winches are often used in locations and settings with limited real estate to place and mount the winch. For example, industrial marine winches are generally attached to the deck of a vessel and are limited to specific regions of the vessel due to size clearances. Many conventional winches are not optimally configured to reside in limited spaces such as the deck of a vessel. Typical winches are configured with the motor assembly and other auxiliary components positioned adjacent to the winch drum, creating a large footprint on the deck. The overall housing for the assembly of the winch often comprises a large protective housing with an additional case for containing the motor assembly to prevent damage from external forces such as water, salt, dust, and other environmental and circumstantial conditions to the electronics. This extra space consumed by the protective winch housing makes it difficult to secure the winch in certain positions or at certain angles on the already limited vessel deck, thereby limiting the effectiveness of the winch.

Furthermore, the conventional housings are also not conducive to motor access as the motor assembly and other components have been fit tightly within the housing and sealed from the outside environment. Maintenance or repair to the motor assembly requires extensive dismantlement of the housing and/or winch assembly, consuming additional time and manpower. Providing easy access to the main motor assembly is a valuable feature especially when maintenance of the winch is necessary at the site of operation.

Prior efforts to integrate the entire winch motor assembly into the winch drum have encountered problems mainly due to the dispersal of heat. It is often difficult to provide a motor with the necessary torque capacity for the hauling purposes while adequately dispersing the heat generated by the enclosed motor assembly which is most often enclosed to protect the motor components from the external environment (e.g., water, salt, dust). While some internal motor designs utilize a completely closed drum filled with oil to surround the motor assembly and diffuse heat, this method precludes access to the motor assembly without complete drainage of the oil and the dismantlement of the winch. Other conventional methods have employed a series of electric fans to blow air through channels to cool the motor assembly, requiring additional components, maintenance, and energy.

Additionally, at the site of operation, more than one size winch is often required to manage the various vehicles or loads as each winch is usually only compatible with one cable type and/or cable length, limiting the weight hauling capacity and depth range of deployment. Few winches are currently available which allow the mounting of a plurality of cable types and lengths particularly both cable wire and synthetic rope.

Winches are hauling or lifting devices that are used to play out, or haul in a length of rope, chain, cable, line, or other type of tension member. Lines used on a winch are gene generically referred herein as “tension members”. Proper wrapping of the line is crucial for proper operation of the winch. Line wrapping is the process of adding wraps of lines (i.e., a “line wrap”) to the winch drum. A line wrap is a single turn of the line around the drum. Line wraps are added consecutively, from one end of the drum to the other. Once complete, a set of line wraps is referred to as a wrap level. A proper wrap level does not have gaps between line wraps and no two line wraps of a single level are on top of or underneath another. In typical winch operation, as tension member is hauled onto the winch drum, the tension member is added in many wrap layers.

Improper wrapping can result in uneven wrap layers, build-up on the drum sides, and ‘diving’, where the tension member from one wrap layer is forced down into the layer below it. Uneven forces are applied to the tension member when improperly wrapped tension member is played out, applying unnecessary and dangerous stresses to the tension member and the attached gear. In the best cases, stress forces can damage the tension member, reducing lifetime, result in tangling that stops tension member movement, or damaging the winch motor. In the worse cases, stress forces can snap a tension member, resulting in equipment loss and life-threatening snap-back towards the winch and winch operator.

Drawbacks in the commonly known level wind systems are, significant. Sheave diverter level winds typically have three structures, two offset supports and a leadscrew. The offset between sheave center and weight-bearing supports introduces a significant moment arm. A moment arm is the length between an axis (e.g., the support) and the force acting on it (e.g., the tension member going through the sheave). The longer the moment arm, the more force that is built up. Moment arms are useful when removing a tight fixture (i.e., with a long-handled wrench), but present a serious problem in the moving, highly stressful environments of a marine winch level wind.

Furthermore, due to their construction, the commonly utilized level wind systems cannot take advantage of benefits of a system situated immediate to the spooling device. Namely, a sheave or guide that moves the tension member onto or off the spool experiences the actual load of the wire as it moves. When weight-bearing is loaded onto a plurality of supports, the load of the wire cannot be easily measured. Common winch apparatuses use a computational method and overall winch assembly weight (including winch drum, motor, and support super structure) to calculate load. A calculated load is significantly prone to error.

Therefore, having a versatile, compact industrial winch with a motor assembly that is accessibly secured within the winch drum and is also capable of mounting to multiple positions on a platform and handling a plurality of hauling needs is greatly advantageous in both the marine and land setting. It is also therefore desirable to reduce the complexity and forces applied to a winch level wind apparatus, while preserving the level wind functionality. An object of the present invention is to overcome the aforementioned problems, and to further improve the functionality of the level winding and winching system.

### SUMMARY OF THE INVENTION

The invention relates to a compact, low profile winch for hauling and retrieval purposes in a variety of land, offshore, and aquatic applications, particularly in a marine environment including the deployment and retrieval of mooring lines, floats, buoys, underwater vehicles, scientific instruments, or other loads. In one or more embodiments, a lightweight, industrial winch, is discussed herein, generally comprising: a horizontal winch drum for storing cable, rotatable in a forward and reverse direction, further comprising a non-load bearing flange on each axial end; a disengagable motor assembly comprising a motor, a gearbox, and a housing; a drive means; a bearings means; a base; and a quick removal means; wherein the motor assembly is self-centered within the housing, the housing entirely disposed within the winch drum with a gap between the outer face of the housing and the inner face of the winch drum, and the housing is connected to the base; the motor assembly is engaged with the winch drum by means of the drive means at one axial end; the bearing means supports the winch drum, and the bearing means is attached to an axial end of the winch drum and is attached to the base; the motor assembly may be disengaged from the winch drum using the quick removal means without dismantling the entirety of the winch; and the winch is capable of hauling and supporting a heavy load on a cable.

An object of the present invention is to provide an improved level winding system to simplify and reduce the weigh, complexity, and size of the level wind system for winding a tension member about a winch.

Another object of the present invention is providing a level wind system with a single support member, often utilizing a hollow support to reduce complexity of the system. Another object of the present invention is to provide direct tension member metering and load sensing.

This invention features a level wind system for applying a tension member onto a winch, the system including a support, a leadscrew, a guide, a motor, and a shuttle. The motor being connected to the leadscrew and configured to apply a motive force onto the leadscrew. The leadscrew is connected to the shuttle, which is in turn connected to the guide. The shuttle is designed to transfer the motive force from the leadscrew onto the guide. The guide rests on, and is supported by the support, and is configured to (i) move along the support, (ii) receive a tension member, and (iii) transfer any force experienced by the tension member onto the support. The system is further defined by the support being positioned substantially between the leadscrew and the guide.

In some embodiments, the support is at least partially hollow, or has a void in its interior, and the leadscrew is substantially within the support. In some of the preceding embodiments the support further has an opening along its lateral length, allowing the shuttle to connect the leadscrew from within the support to the guide outside the support. In some embodiments, the support shares the same longitudinal axis with the leadscrew. In a set of the preceding embodiments, the guide also shares the same longitudinal axis as the leadscrew and support. In some embodiments, the leadscrew and guide share the same longitudinal axis. In other embodiments, the leadscrew has one longitudinal axis, and the guide and support share a different longitudinal axis.

In some embodiments, the support is divided into two ends on either longitudinal end of the support and these ends are adapted for the system to be mounted onto a winch. In some embodiments, the system further has two flanges, each flange on one longitudinal end of the support and the flanges are adapted to be mounted onto a winch. In some embodiments, the system further includes a controller and a position sensor, where the controller partitions and assigns different regions (i.e., partitions) of the winch drum for different tension members and different operations by the guide.

In one embodiment, the level wind system has no additional supports, and is limited to the single elongate support described above. In some embodiments, the motive force from the motor applied to the leadscrew is rotational, and the leadscrew rotates about its longitudinal axis in response to that motive force.

In some embodiments, the guide further has a first and second portion, the first portion being rigidly connected to the shuttle, and the second portion being moveable about the first portion. In some embodiments, the second portion rotates about the first portion. In additional embodiments, the second portion rotates about the common axis of one of the leadscrew and support. Some embodiments further include a load sensor on or within the first portion of the guide and a controller connected to the load sensor; where the load sensor measures the force experienced by the tension member and applied to the guide, and sends those measurements to the interconnected controller. In some of these embodiments, the load sensor is connected the controller wirelessly, in other embodiments it is connected by a wired-connection.

Some embodiments, the system further includes a metering sensor and a controller, the metering sensor measuring the movement of the second portion, the movement being in response to movement of the tension member, and the metering sensor sends these measurements to the controller.

This invention may also be expressed as a method of winding a tension member about a winch. The method includes the steps of selecting a level wind system including a support, a leadscrew, a guide, a motor, and a shuttle. The motor being connected to the leadscrew and configured to apply a motive force onto the leadscrew. The leadscrew is connected to the shuttle, which is in turn is connected to the guide. The shuttle is designed to transfer the motive force from the leadscrew onto the guide. The guide rests on, and is supported by the support, and is configured to (i) move along the support, (ii) receive a tension member, and (iii) transfer forces experienced by the tension member onto the support. The method includes mounting the level wind system onto a winch, applying a tension member to the guide of the system, and operating the winch to spool the tension member to and from the winch. During operation, the tension member applies a force onto the guide, which is transferred to the support.

In certain embodiments, the method includes the guide further having a first portion, a second portion and a load sensor, where the first portion is fixedly attached to the shuttle, the second portion is movably attached to the first portion and the load sensor being within or on the first portion. The load sensor is adapted to measure the force applied by the tension member onto the guide and directs those measurements to an interconnected controller. In some embodiments, the method includes selecting a system where the support has a longitudinal axis that is shared by the longitudinal axis of the guide. In some embodiments, the method includes selecting a system where the support is substantially hollow and where the leadscrew is substantially within the interior of the support. In some embodiments, the method includes selecting a system where the support shares a longitudinal axis with the leadscrew.

### BRIEF DESCRIPTION OF THE FIGURES

The drawings constitute a part of this specification and include exemplary embodiments of the Compact Winch apparatus, which may be embodied in various forms. It is to be understood that in some instances, various aspects of the invention may be shown exaggerated or enlarged to facilitate an understanding of the invention. Therefore, the drawings may not be to scale; instead, emphasis has been placed upon illustrating the principles of the invention. In addition, in the embodiments depicted herein, like reference numerals in the various drawings refer to identical or near identical structural elements. Embodiments of the present invention are represented in the accompanying drawings, wherein:

FIG. 1 is an overview schematic of one illustrated embodiment of the invention;

FIG. 2 is a longitudinal cross section schematic of one embodiment of the invention, illustrating the motor assembly and drive means disposed within the winch drum;

FIG. 3 is a side view schematic of one embodiment of the invention;

FIG. 4 is a top view according to one embodiment of the invention;

FIGS. 5A and 5B are two side view representations of one embodiment of the present invention, FIG. 5A is a schematic side-view of the components, and FIG. 5B illustrates the one dimensional force applied to the support member from the tension member;

FIG. 5C is a side view representation of a second embodiment of the present invention, comprising two support members, both support members being internal to the guide;

FIGS. 6A and 6B are two, opposing side views of one embodiment of the present invention as it would be suspended above or next to a winch apparatus (not shown);

FIG. 7 is a cross-sectional view of the level wind system;

FIG. 8A is a close-up cross-sectional view of FIG. 7, illustrating the internal components of the guide in more detail;

FIGS. 8B-8E are illustrations of the receptacle according to four embodiments;

FIGS. 9A-9D are four representations of the guide according to the present invention; FIG. 9A is an angled side view of the guide illustrating the first and second portions as well as the support and opening. FIGS. 9B-9D are side views of the guide illustrating the internal components according to different embodiments.

FIGS. 10A-10C are three illustrations of the shuttle and hub of the first portion;

FIG. 11 is an example of a flange according to one embodiment;

FIG. 12 is an overview, front, cross-sectional view of a winch assembly with a level wind system mounted above the winch; and the level wind system shown including a position sensor enabling partitioning of the winch drum; and

FIG. 13 is a cross-sectional, frontal view of an embodiment having a guide and load-supporting leadscrew and no support member.

### DEFINITIONS

The term “tension member” used herein encompasses all types of structures adapted to be spooled by a winch apparatus. Common types and terms such as “line”, “cable”, “rope”, “wire” and “chain” are included as tension members. These terms are typified by a length of approximately cylindrical structure of various make-up. Tension members includes natural and synthetic braded fiber, braded and unbraded metallic wire, multi-layered cables, CTD cables and the like.

The term “drum” as used herein refers to the drum of a winch that accepts a tension member, most often as multiple levels of wrapped tension member. The term drum further includes reels, spools, and other like structures adapted for tension members.

The term “central axis” is used herein to describe the typically longitudinal axis of at least one of the leadscrew, the support member, and the guide. In embodiments where more than one component shares the same central axis (i.e., they are coaxial), the central axis may be referred herein as the “common central axis.” In the currently preferred embodiment, the leadscrew, support member and guide all have a single, common central axis.

The term “load sensor” as used herein generically refers to a mechanism that detects a load, pressure, or other stress placed on or between two components. Load sensors are also commonly referred to as “load pins” or “load cells” and these terms are meant to be interchangeable with load sensor. A load sensor detects the force applied across the sensor, often by strain gauges installed within a small bore through the center of the sensor pin; grooves may be machined into the circumference of the pin to define the shear planes, each plane located between the forces to be measured.

The terms “shuttle” and “connection means” as used herein refer to the mechanism by which the guide interacts with the leadscrew and the leadscrew's force (e.g., rotational force) is translated into motion of the guide. The translated motion moves the guide along the support member, parallel to the leadscrew's central axis. The shuttle is also commonly known as a nut, or split nut, ball nut, or follower.

The term “leadscrew” as used herein refers to the linking mechanism that translates a first motion (i.e., rotation) to a second motion (i.e., linear movement). Most often the linking mechanism is a mechanical linkage, embodied by an assembly of connected bodies to manage forces and movements. In the preferred embodiment, the leadscrew is a threaded, elongated cylinder connected to a motor. Here the word elongated is defined as the common adjective form of the word, meaning slender or longer in one, longitudinal dimension than other dimensions. The term leadscrew encompasses other suitable screw-like and non-screw-like mechanisms. For example, the leadscrew may comprise pneumatic or hydraulic actuators, power screws, or translation screws. Common applications include linear actuators, machine slides (e.g., in machine tools), vices, presses, and jacks.

The term “longitudinal” as used herein refers to the lengthwise dimension of a given component. For example, a longitudinal axis as described herein, is the lengthwise axis of a component, for example the elongate support 102, depicted in FIG. 7.

The term “guide” as used herein refers to a diverting mechanism designed to at least partially restrain and to change the direction of a tension member. Most often, the guide receives the tension member from a first direction outside of the system described herein (e.g., a ship's a-frame) and redirects it to the winch drum. The guide moves on an axis parallel to the winch drum's longitudinal axis such that it is positioned to deposit successive portions of a tension member in a level wrap on the winch drum, without creating gaps between tension member wraps, or doubling tension member layers during a single transect between winch drum ends.

The terms “winch” and “winch apparatus” as used herein is defined as any device or mechanical assembly designed to spool or wrap at least one tension member around a rotating drum. Most often winches are used as hauling, lifting or hoisting devices, by attaching a tension member to both the winch and an object to be manipulated.

### DETAILED DESCRIPTION OF THE ILLUSTRATED EMBODIMENTS

The subject matter of the present invention is described with specificity herein to meet statutory requirements. However, the description itself is not intended to necessarily limit the scope of claims. Rather, the claimed subject matter might be embodied in other ways to include different components or combinations of components similar to the ones described in this document, in conjunction with other present or future technologies.

Furthermore, the described features, structures, or characteristics may be combined in any suitable manner in one or more embodiments. In the following description, numerous specific details are provided, such as examples of platforms, winch components, motors, propulsion means, attachment means, drum bodies, cords, cables, drive means, and other various components. One skilled in the relevant art will recognize, however, that the Compact Winch apparatus may be practiced without one or more of the specific details, or with other methods, components, materials, and so forth for numerous uses. In other instances, well-known structures, materials, or operations are not shown or described in detail to avoid obscuring aspects of the invention.

Unless defined otherwise, the terminology used herein has the meaning commonly understood by a person skilled in the art to which this invention belongs. As used herein, the following terms have the meanings ascribed to them below, unless otherwise specified.

When a component is referred to as being “on,” “engaged to,” “connected to,” “attached to,” or “coupled to” another component, it may be directly on, engaged, connected or coupled to the other element or layer, or intervening components or layers may be present.

In contrast, when a component is referred to as being “directly on,” “directly engaged to,” “directly connected to,” or “directly coupled to” another component, there may be no intervening components or layers present. Other words used to describe the relationship between elements should be interpreted in a like fashion (e.g., “between” versus “directly between,” “adjacent” versus “directly adjacent,” etc.).

As used herein, the term “and/or” includes any and all combinations of one or more of the associated listed items.

As used herein, the singular forms “a,” “an,” and “the” may be intended to include the plural forms as well, unless the context clearly indicates otherwise.

In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

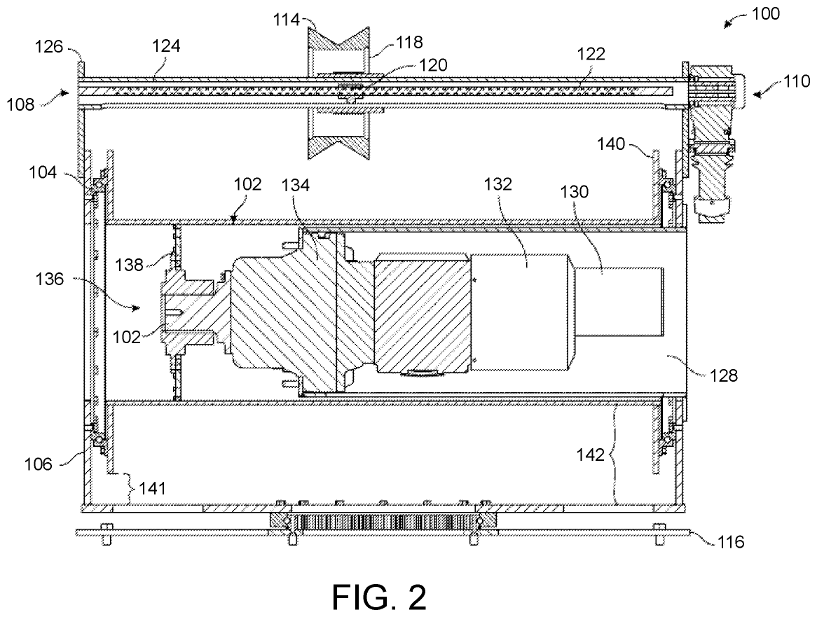

The present invention describes a lightweight, industrial winch design for use in a plurality of configurations and applications, particularly in the marine environment. While the winch 100 may be used in any suitable capacity, overall, the winch 100 is capable of hauling and supporting a heavy load on a cable such as a vehicle (e.g., an autonomous underwater vehicle (AUV), a remotely operated vehicle (ROV), a human occupied vehicle (HOV), a glider, or the like), a crate, a scientific instrument, deck equipment, moorings, or any other loads which require or may benefit from mechanical lifting, deploying, or supporting. As illustrated in FIG. 2, the winch 100 described herein provides a compact design which involves a motor assembly 130 disposed evenly within the internal space of the winch drum 102 by a housing 128 connected to and centered by the winch base 106 of the winch 100. Coupled to the winch drum 102 is a narrow profile bearing means 104 which reduces the side clearance of the overall system while providing a reliable, smooth rotation about the longitudinal axis of the drum and managing the heavy torque cabled load. The bearing means 104 is secured to a fixed winch base 106 designed to support the winch drum 102 and other internal elements using an amount of material for reduced weight and size considerations.

The winch 100 comprises a motor assembly 130 residing within the housing 128 which disengagably (e.g., removably) slides into an axial end of the winch drum 102. The removable installation of the motor assembly 130 is aided, in some embodiments, by the self-centering feature of the compact housing 128, as shown in FIG. 2. Another particular feature of this assembly method is the ease of accessibility to the motor assembly 130 for replacement or maintenance, an ability which is often made difficult by the bulky frame or inconvenient access points of conventional winches. The motor assembly 130 may be removed or at least easily accessed by one side end of the stationary housing 128, as illustrated in the side view of FIG. 2.

As the depicted embodiment of the present invention uses a winch drum 102 open (i.e., unsealed) on at least one axial end, passive air is allowed to flow through and around the motor assembly 130 to dissipate heat without hindering access to the motor assembly 130 or requiring added cooling components. In additional embodiments, the winch drum 102 is open on one end, while in alternate embodiments it is open on both ends. In yet alternate embodiments, the winch drum 102 has apertures to allow air to pass into it. Furthermore, centering the motor assembly 130 via a housing 128 within the winch drum 102 allows more surface area of the motor assembly 130 to be air-cooled.

As shown in FIG. 2, the integration of the motor assembly 130 reduces the overall height profile of the winch 100 unit as compared to a conventional winch which typically disposes its motor assembly in a case adjacent to, or at a raised position around, the winch drum 102. Moreover, the integration of the motor assembly 130 into the winch drum 102 frees additional area above and around the winch drum 102 to permit the rearrangement of the level wind mechanism 108. The reduction in height clearance also allows the winch 100 to fit and operate within areas of lower clearance previously inaccessible to conventional winch models.

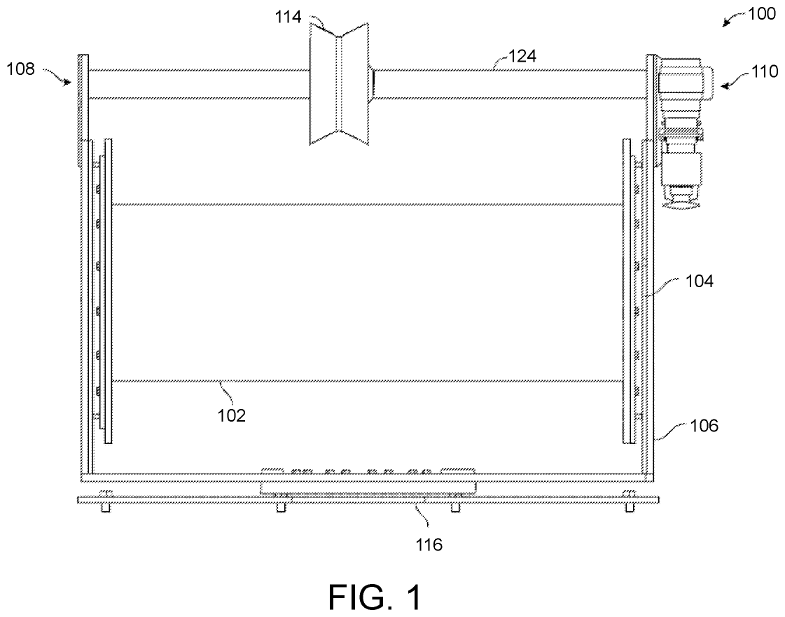

The overall footprint of the winch 100 is also substantially reduced by the new design, which further expands the possible attachment or operation positions of the winch. This decrease in footprint will have immediate impact in numerous fields of use such as the marine environment where space on a vessel is limited. Conventional winches routinely require large and bulky frames to secure the winch, the motor assembly, and the plurality of other components. The inventive winch 100, as illustrated in FIG. 1, is largely defined by the size of the winch drum 102 when the winch 100 is mounted directly onto a platform by the winch base 106. In various embodiments such as the one as shown in FIG. 2, the winch 100 may also be utilized with a low profile turntable 116 or other suitable mounting base as would be readily identified by one having ordinary skill in the art in light of this disclosure, which redefines the footprint of the winch 100 to the size of the turntable 116. Even in such embodiments, the winch 100 still consumes less deck space for operation than conventional winch constructions and may also be rotationally adjusted.

The side clearances of the inventive winch 100 is also condensed by replacing the conventional pillow blocks typically used in winch constructions for rotation with a slimmer bearing means 104, which in preferred embodiments are lightweight rolling element bearings (e.g., slewing bearings) with the strength capacity and force resistance equal or greater than heavy pillow block bearings or similar mountings.

The overall size reduction adds additional advantages which can be seen in various embodiments including lighter weight, easier transportation, simpler installation, and/or cost-effective fabrication. In at least one embodiment, the winch 100 requires no additional housing or framing; however, the winch 100 may be integrated into an existing housing or frame to mount to a desired position on a platform. In many cases, the winch 100 may be easily manually adjusted due to the reduction in weight and/or size.

The winch 100 also includes an improved lightweight level wind mechanism 108 which further reduces the winch's 100 size clearance and weight. Conventional winch constructions spool the cable through the level wind mechanism 108 disposed at a frontal position level with the winch drum 102. At this position, the level wind must bear the weight and torque of the cabled load which most often requires a high strength double beam design. One or more embodiments of the inventive winch 100 reduces the level wind mechanism 108 to a single lightweight beam 112 arranged above the winch drum 102 to remove any substantial torque forces from bearing upon the level wind mechanism 108 during operation. Alternate embodiments may move the single lightweight beam 112 to other suitable non-load bearing positions. The level wind motor assembly 110 is often mounted to the winch base 106 keeping the profile of the winch 100 as compact as possible.

As previously mentioned, the motor assembly 130 may be easily accessed and disengaged from the winch drum 102 via the quick removal means. As various vehicles or loads may be deployed and retrieved with a winch, it is common to have more than one size or type of winch available on site in order to manage all of the loading demands. One feature provided by various embodiments of the inventive model is the ability to utilize a plurality of cables or ropes of various type, length, and/or gauge (e.g., diameter), including synthetic rope, which may be exchanged with the inventive winch 100 to suit a specific load. Likewise, it is an object of at least one embodiment of this invention to provide a winch wherein the winch drum and/or motor assembly may be timely exchanged to one of suitable abilities for the task at hand and limit the individual winches required.

As shown in FIGS. 1 and 2, the motor assembly 130 is disposed within the winch drum 102, wherein the motor assembly 130 engages a drive means 136 to translate the power generated from the motor 132 into rotational force, driving the forward or reverse turning motion of the winch drum 102 during operation. At one end, the drive means 136 engages the motor assembly 130 while at the other end the drive means 136 is attached to the drum engagement means 138. The drum engagement means 138 connects to a portion of the winch drum 102 to provide drum rotation.

Rotation of the winch drum 102 is further facilitated by the bearing means 104 which is generally disposed on one or both adjacent axial ends of the winch drum 102. The winch drum 102 is attached to the rotatable inner surface of the bearing means 104, while the fixed outer surface of the bearing means 104 connects to the winch base 106 (which comprises the winch frame and drum mount). In some instances, the winch base 106 is directly mounted to the platform but is often attached to a turntable 116 which is attached to the platform.

The system comprises additional components such as the level wind mechanism 108 which is attached to the winch base 106 and in contact with the cable being wound about the winch drum 102. The level wind mechanism 108 is powered by the level wind motor assembly 110 to drive rotation of the lead screw 122 and screw nut 120 which is attached to the carriage 118 engaged with the sheave 114. The cable wound about the winch drum 102 passes over the sheave 114 to connect to the vehicle, heavy load, or other rigging for deployment/retrieval.

Another advantageous aspect of the present embodiment is the redesigned portable controller to provide remote operation around the platform. The motor assembly 130 is connected to a power source and is regulated by the controller. The controller may plug into a suitable terminal wherein the terminal is appropriately connected to the motor assembly 130 to signal control of motor speed and rotation direction.

### Winch Drum

The winch 100 comprises a horizontal winch drum 102 for storing cable and withstanding distortion under applied torque and tension forces. As illustrated in FIG. 2, the winch drum 102 holds the motor assembly 130, stores the cable wrapped around the winch drum 102 in successive layers, and is rotatable in a forward and/or reverse direction. In order to provide a compact and heavy load-bearing winch, the winch drum 102 maintains adequate load-bearing abilities to transfer and manage the load forces off of the flanges 140 which are often a weak link in winch design. Thus, the flanges 140 may be constructed to be non-load bearing flanges. The cable attaches to the winch drum 102 or other portion of the winch 100 and is wound around the longitudinal axis of rotation preferably in an even distribution along the length of the winch drum 102. The winch drum 102 may be any suitable drum, reel, spindle, or body to wind and reel out cable for the intended hauling purposes. In some embodiments, the winch drum 102 is interchangeable with another winch drum appropriate for the task.

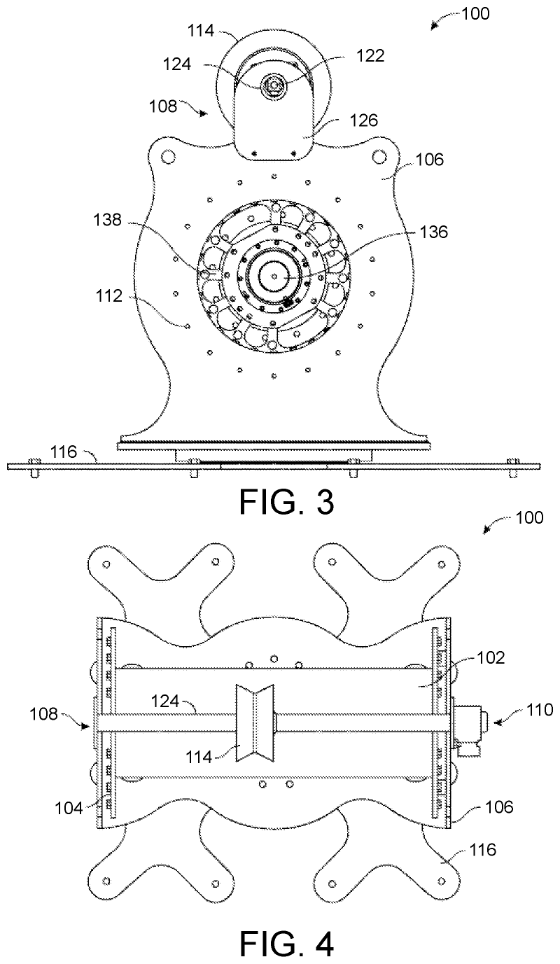

The winch drum 102 is generally a horizontal cylindrical shape open (i.e., unsealed, accessible, exposed, or at least partially open) on at least one axial end, preferably open on both of the axial ends (as illustrated in FIG. 3) to further eliminate excess material and to provide air cooling to the motor assembly 130 disposed within the winch drum 102. In specific cases where the winch 100 may be submerged, heavily splashed with fluid, or exposed to damaging environmental conditions, the winch drum 102 is partially sealed or completely sealed. Disposed on at least one and preferably each axial end of the winch drum 102 is a flange 140.

### Flanges

In conventional winch constructions, the flange is an integral structural member of the winch which bears the torque forces applied during winch operation. In design of the flange, it is general practice to provide a flange at each end of the drum to resist the lateral and torsional forces and crushing cable load during winch operation. The flange of those constructions must be of a diameter and thickness to prevent shearing or deforming under force and maintain uniformity and parallel drum ends which in some cases requires heavy reinforcing webs or trusses to further strengthen the flange. Such reinforcements add more weight and cost to the winch. The present inventive winch 100 shifts the torsional forces off of the flanges 140 and onto the winch drum 102 to lessen the need for reinforced additions and reduce material and weight while providing comparable hauling capacity for industrial purposes.

The flanges 140 are secured (e.g., welded, bolted, adhered, mechanically attached) at each axial end of the winch drum 102 to prevent overspill of cable off of the drum 102. Overspill of the cable occurs when the cable jumps out of its designated position on the winch drum 102 or is not wound directly adjacent to the already laid cable. By replacing the traditional bulky pillow block bearings with the highly reliable and high strength bearing means 104, the winch 100, particularly the winch drum 102, is capable of bearing more force (e.g., heavy load) to reduce the strain on the flanges 140. Thus, the flanges 140 are designed to be non-load bearing in some embodiments which allows for manufacture from a lighter and/or thinner material to further facilitate a lightweight, compact design. For example, conventional winches may require the flanges to be constructed from 3¼″ thick steel whereas the winch 100 may be made of a material less than 3¼″ thickness, be it steel or a lower strength, more cost-effective material. In some embodiments, the flanges 140 are less than ¼ inch, less than ½ inch, less than 1 inch, less than 2 inches, less than 3 inches, or equal or greater than 3¼ inches thick. However, the flanges 140 are preferably constructed from an appropriate material and set of specifications to maintain proper form and resist shearing. The diameter of the flange 140 is most often determined by the diameter of the winch drum 102 and the amount of flange 140 exposed radially past the top layer of the wrapped cable (i.e., freeboard).

In some embodiments, one or more additional flanges 140 is provided at a vertical middle position on the winch drum 102 (e.g., split drum) to allow more than one cable to wrap around the winch drum 102 without entanglement (e.g., interaction).

The winch drum 102 may be any suitable size for the desired application. In general, the winch drum 102 is kept to a compact size to house the motor assembly 130 and to withstand torque and other forces without deforming. However, other considerations for diameter size include the speed of rotation and the cable storage capacity. In some embodiments, the winch drum 102 is the same size as a conventional winch drum. In other embodiments, the drum 102 is larger in diameter than conventional drums. When a larger winch drum 102 is selected, greater torque is generated, and the winch drum 102 rotates at a slower speed in comparison to a smaller diameter winch drum 102. Slower rotation may be beneficial in some cases as the slower speed and reduced number of turns reduces wear and tear on both the cable and the mechanical components of the winch 100 to extend the lifespan. In some embodiments, a larger winch drum 102 is used for the subject invention for the above reasons which may be accommodated by the reduction in winch size by the narrow bearing means 104, the level wind mechanism 108 arrangement, the internally disposed motor assembly 130, and/or a combination of the aforementioned components.

The winch drum 102 is generally constructed from a high strength material and designed to a specific thickness to adequately resist distortion by torque and tension forces applied under load. In conventional winch designs, a level wind is often a structural member of multiple high strength beams to bear a significant portion of the applied forces; however, as many embodiments of the inventive winch 100 utilize the disclosed level wind mechanism 108, the winch drum 102 bears most and in some cases, all of the applied forces. In other embodiments, the winch drum 102 may bear only a portion of the applied forces. Suitable materials are described in more detail below. As discussed herein, the thickness of the winch drum 102 is measured as the distance of material between the inner face of the winch drum 102 to the outer face of the winch drum 102 which can vary depending on the needed weight-bearing capacity. In some embodiments, the winch drum 102 is less than ¼ inch, about ¼ to ½ inch, about ½ to 2 inches, about 2 inches to 5 inches, or greater than 5 inches thick.

In one or more embodiments, the winch drum 102 is substantially smooth or at least grooveless to accommodate different types and sizes of cable and may rely on the level wind mechanism 108 or other suitable method to evenly distribute the cable on the winch drum 102 during operation. In other embodiments, the winch drum 102 is grooved to assist with symmetrical cable loading/winding. The grooves can be cast on the winch drum 102 or machined as separate pieces that are mechanically affixed to the winch drum 102. In various applications of such an embodiment, it may be desired that the grooves be slightly larger than the cable in use to avoid pinching and allow cable to adjust itself to the curvature of the winch drum 102, although this would not be necessary for every embodiment to function.

In yet some alternate embodiments, the winch 100 utilizes a split winch drum 102 for providing one or more cables on the same winch drum 102.

### Motor Assembly

The motor assembly 130, which is disengagable in some embodiments, provides the power and control of rotation to turn the winch drum 102 for extending and retrieving the cable and the attached load. As further depicted, the motor assembly 130 is disposed at least partially.) if not entirely within the housing 128. For example, in alternate embodiments, this may mean that only the gearbox 134 is disposed internally, half of the motor assembly 130 disposed internally, half is disposed internally, three quarters of the motor assembly 130 is disposed internally, or the like. In many embodiments such as the one shown in FIG. 2, the motor assembly 130 may be mounted within the housing 128 with the motor axis parallel to the winch drum 102 axis of rotation. In many embodiments, the motor assembly 130 is engaged with the winch drum 102 by means of the drive means 136 on at least one axial end.

The disengagable motor assembly 130 comprises the motor 132, the gearbox 134, the housing 128, a motor brake, and a controller. A feature of the present invention is the flexibility to integrate numerous suitable motor assemblies 130 within the housing 128 which can then be easily removed without the complete dismantlement of the winch 100 through the quick removal means. While most constructions integrate a single motor assembly 130 into the winch drum 102, additional embodiments are envisioned to include multiple motors (e.g., 2, 3, 4, 5, 6, 8, 10 motors or more) within the internal space of the winch drum 102, of the housing 128, or other component. The multiple motors may be arranged in any suitable fashion, but in most cases are evenly distributed (such as radially distributed in some embodiments) to balance weight and torque forces. For example, in embodiments comprising multiple motors, each of the multiple motors may be provided within an individual housing 128 within the winch drum 102 or may be arranged together within a single housing 128 in the winch drum 102.

The motor 132 is generally an electric motor. However, the winch 100 and the motor assembly 130 are readily adaptable to allow different types and sizes of motors and motor components like a gearbox, motor brake, and/or drive means to be utilized. In order to be a “suitable” motor, the motor 132 must be able to provide the necessary torque for the intended use and accommodate the size and weight parameters of the cabled load. In addition to common electric motors, other motors that may be suitable include without limitation synchronous motors, induction motors, AC motors, DC motors, slip ring motors, hydraulic motors, permanent magnet motors, or any motor suitable for integration into a compact region. In a certain embodiment, the motor 132 is a variable speed DC electric motor.

### Gearbox

The gearbox 134 transmits the force generated by the motor 132 to a plurality of gears arranged in an assembly which revolve and rotate the drive means 136. The gearbox 134 is generally matched to the motor 132 to mechanically fit and provide adequate rotation of the drive means 136. In many cases, the gearbox 134 is a helical gear assembly engaged with the motor 132 and the drive means 136, although other gears such as planetary gears, worm gears, or the like may be used. In many embodiments, the gearbox 134 is a compact arrangement of gears disposed in a closed housing 128 to protect the gears from environmental factors such as water, salt, or dust. In some constructions, the gearbox 134 is filled with oil or other fluid like lubrication, mineral oil, synthetic oil. In other cases, the gearbox 134 is not filled with fluid or may comprise openings.

### Motor Brake

The motor assembly 130 includes a motor braking system to slow down, stop, and prevent rotation of the winch drum 102 such as when a load is held in midair or disposed off of the platform or the winch 100 is not in operation. Suitable motor brakes depend on the type of motor 132 in use with the winch 100. In general, the motor brake acts in an On/Off manner, allowing or preventing rotation of the winch drum 102. In some embodiments, the motor brake is used to regulate or limit the speed of the winch 100. Suitable braking systems for the motor assembly 130 include an electrical dynamic brake, a hydraulic brake (which may comprise a wet disc, dry disc, and/or band), electric brake, a fail-safe brake for automatic stop for power interruption), a manual brake, a locking pawl (ratchet) brake, a magnetic brake, or other suitable braking means.

In some embodiments, the motor brake acts upon the motor 132 or other appropriate motor component. In some embodiments, the inner or outer surface of flange 140 provides a surface for a motor brake (i.e., the brake disc) to press against to prevent rotation of the winch drum 102. In other embodiments, the motor brake is fitted to act upon the winch drum 102.

### Power Source

The motor assembly 130 is connected to a power source by a means known to one skilled in the art. In some embodiments, a suitable cable or terminal connects the motor assembly 130 to the power source through a means such as a junction box. The power source may be any suitable means for providing the energy to drive rotation for the winch 100 such as a battery, hydraulic power pack, power generator, but in most cases is a plug-in connection to a nearby outlet.

### Housing

As illustrated in FIG. 2, the housing 128 accommodates and secures the motor assembly 130 in a steady and immobile manner relative to the rotatable winch drum 102. The motor 132 and the gearbox 134 are supported within the housing 128 wherein the gearbox 134 projects through the housing 128 to engage the drive means 136. In some embodiments, the motor assembly 130 is supported in the housing 128 by attaching to a portion of the housing 128 which may be to the end of the housing 128 disposed in the winch drum 102, to the middle inside of the housing 128, to the end of the housing 128 connected to the winch base 106, and/or any other suitable position in or on the housing 128. In some embodiments, the housing 128, comprising the motor assembly 130, is supported (e.g., connected, mounted) by the connection to the drum engagement means 138 and to the winch base 106.

In the depicted embodiment, the housing 128 is capable of sliding into the winch drum 102 wherein one end of the housing 128, comprising the motor assembly 130, is disposed within the winch drum 102 with a gap or space between the outer face of the housing 128 and the inner face of the winch drum 102, and the second end of the housing 128 is connected to the winch base 106. The motor assembly 130 is most often self-centered within the housing 128. The self-centering feature of the winch 100 is provided by securely attaching the housing 128 (disposed within the winch drum 102 and comprising the motor assembly 130) to the winch base 106. When the housing 128 is attached in stationary position to the winch base 106, the winch drum 102 and the bearing means 104 are free to move independently relative to the housing 128. In some embodiments, the gap between the outer face of the housing 128 and the inner face of the winch drum 102 may be less than 12 inches, less than 10 inches, less than 8 inches, less than 6 inches, less than 4 inches, less than 2 inches, less than 1 inch, less than 0.5 inch, or less than ¼ inch, while in other embodiments it may be greater.

In at least one embodiment, the housing 128 enters one axial end of the winch drum 102 by sliding through an open portion on the side of the winch base 106 which is aligned with the center of the bearing means 104, as shown in FIG. 2. The housing 128 attaches to the outer surface of the base 106 (or any other suitable portion of the winch) using attachment means 112 (which may comprise nuts bolts, pins, grooves, welds, rivets, threaded fasteners, and/or other suitable fittings) to center the housing 128 within the winch drum 102. When the housing 128 is disposed within the winch drum 102 and secured to the winch base 106, the housing 128 is stationary with respect to the rotatable winch drum 102, and the space between the inner face of the winch drum 102 and the outer surface of the housing 128 does not vary when the winch 100 is in operation. Furthermore, in many embodiments, the outer diameter of the housing 128 remains equal distance from the inner face of the winch drum 102 along the longitudinal length of the housing 128. In many embodiments, the attachment means 112 securing the housing 128 to the winch base 106 are evenly distributed about the circumference of the housing 128, as shown in FIG. 3.

The motor assembly 130 is disposed within the housing 128 with a space between the inner surface of the housing 128 and the internally disposed motor assembly 130 to allow air to pass by and cool the motor 100 components. The housing 128 incorporates this ventilation to easily exchange the hot air for ambient or cool(er) air. Furthermore, the housing 128 resides in the winch drum 102 evenly disposed from the inner face of the winch drum 102 as to least hinder airflow through the winch drum 102.

In accordance with a feature of this invention, this compact motor assembly housing 128 may be greatly reduced in size and weight from the standard motor housings or cases. In general, the diameter and length of the housing 128 is dependent upon the size of the motor assembly 130, the diameter of the winch drum 102, and/or the desired gap distance between the outer diameter of the housing 128 and the inner face of the winch drum 102. In some embodiments, the gap is less than ¼ inch, less than ½ inch, ½ to 1 inch, 1 inch to 2 inches, 2 inches to 3 inches, 3 to 5 inches, or greater than 5 inches. In other embodiments, there is no gap between the outer face of the housing 128 and the inner face of the winch drum 102. Additionally, the housing 128 facilitates the connection of the motor assembly 130 with the controller and the power source.

The housing 128 is generally cylindrical in shape with an outer diameter less than the inner diameter of the winch drum 102 to center the housing 128 within the winch drum 102. Other shapes, such as a box, may be used as well so long as the motor assembly 130 is capable of being secured and mounted within the winch drum 102. In some embodiments, the housing 128 is a platform (e.g., plank, slab, support, board) which supports the motor assembly 130 within the winch drum 102. Further embodiments provide a platform which slides in and out of the winch drum 102.

The housing 128 is often comprised of a sheet metal but may be any suitable material capable of resisting deformation in cases of excess heat produced from the motor assembly 130. Such materials that have been identified may include, but are not limited to, aluminum, thermoplastics, steel, and stainless steel. Other materials include the disclosed materials below or any material thereof capable of supporting the weight and operation of the motor assembly 130.

In many instances, the housing 128 is open on at least one axial end of the winch drum 102, preferably both axial ends, to provide adequate passive air flow through and around the motor assembly 130 to dissipate heat and allow easy access to the motor assembly 130. The housing 128 centers the motor assembly 130 within the winch drum 102 to allow more surface area of the motor assembly 130 to be cooled. Air flow may be permitted through both ends of the housing 128 or may be restricted to flowing in and out by one end only. For increased air cooling, an air blower or impeller may be installed to provide active air circulation. In some embodiments, air flow is directed through specific channels (e.g., ducts). In other embodiments, the housing 128 is partially closed on one or more ends or is completely enclosed (e.g., waterproof, liquid-tight).

### Drive Means

The drive means 136 directly engages the gearbox 134 of the motor assembly 130 and connects to the winch drum 102 to translate the torque and power generated by the motor 132 into rotation of the winch drum 102.

The drive means 136 comprises a drive shaft 139 and a drum engagement means 138. In general, the drive shaft 139 is a mechanical part such as a rod, shaft, bar, element, or connection device capable of connecting the motor assembly 130 (most often the gearbox 134) with the drum engagement means 138. When engaged with the drum engagement means 138, the rotation of the drive shaft 134 transmits to rotation of the winch drum 102. The drum engagement means 138 comprises a suitable connection between the drive shaft 139 and the winch 100 to accommodate rotation of the winch drum 102 by way of the turning of the drive shaft 139 which most often is made by a connection to the winch drum 102 but may be any appropriate portion of the winch 100 including bearing means 104 or external portion of the winch drum 102. In some embodiments, the drum engagement means 138 is engaged with the inner face of the winch drum 102. The drum engagement means 138 may be any suitable connector to cause rotation. Exemplary connectors include a disk like a drive plate, flex plate, flywheel, or web, a mount, a bar, a gear, or the like. In one embodiment, the drum engagement means 138 is a metal drive plate which is attached to the inner face of the winch drum 102.

The drive shaft 139 projects from its engagement with the motor assembly 130 gearbox 134 residing in the housing 128 through the hollow center region of the winch drum 102 to connect to the drum engagement means 138. The drive shaft 139 transmits the movement of the gearbox 134 components (i.e., the gears therein) into rotation of the winch drum 102 wherein the drive shaft 139 is rotated about a longitudinal axis by the turning of the gearbox 134 which thereby turns the drum engagement means 138. During the operation of the winch 100, the drive shaft 139 rotates and turns the drum engagement means 138, rotating the winch drum 102 in the forward or the reverse direction. When the winch 100 is stationary, the drive shaft 139 does not rotate.

The drive shaft 139 may connect to the gearbox by any suitable manner now known to or later discovered by those in the art. Examples of suitable connections include, but are not limited to a universal joint, a jaw coupling, a splined joint, a key joint, a Hirth joint, a prismatic joint, or other attachment to align and complete the distance between the motor assembly 130 and the drum engagement means 138 and translate the relative movement of the gearbox 134 to the axial rotation of the drive shaft 139.

### Base

The winch base 106 provides the interface for mounting to the platform (be it the deck of the vessel, truck bed, ground, or other external surface) for secure attachment and support of the winch 100 assembly. The winch drum 102 is mounted across the winch base 106, as shown in FIG. 1; the winch base 106 is connected to one side of the bearing means 104, and the bearing means 104 supports the winch drum 102 by attachment to the flanges 140. The winch base 106 supports the attachment of the level wind mechanism 108, allowing the level wind mechanism 108 to transverse the length of the winch drum 102. In many embodiments, the winch base 106 is capable of mounting to a turntable 116 for rotating the winch 100 about a vertical axis.

The winch base 106 most often comprises a flat mounting surface, however this portion of the winch base 106 may be any appropriate design or shape (e.g., rectangular, square, free form, round) capable of supporting the winch drum 102 and other components securely to the platform. In some embodiments, the mounting surface comprises cutout regions to reduce weight and consumed space (as shown in FIG. 4). The mounting surface may comprise attachment points or holes to attach to a turntable 116 or directly to the underlying platform. In other embodiments, the mounting surface is reduced to a size about the footprint of the winch drum 102.

In several embodiments, the winch 100 comprises a low level winch base 106 wherein the low level winch base 106 allows the winch drum 102 to be mounted substantially close (e.g., low) to the platform to which it is mounted. In some embodiments, the low level winch base 106 supports the winch drum 102 with a substantially close distance 141 between the flange 140 and the mounting surface. Said close distance 141 may be less than 12 inches, less than 10 inches, less than 8 inches, less than 6 inches, less than 4 inches, less than 2 inches, or less than 1 inch. In other embodiments, the low level winch base 106 supports the winch drum 102 at a space 142 between the bottom of the winch drum 102 and the mounting surface wherein the space 142 is less than 36 inches, less than 30 inches, less than 24 inches, less than 18 inches, less than 12 inches, less than 10 inches, less than 8 inches, less than 6 inches, or less than 4 inches.

Furthermore, the distance between the mounting surface of the winch base 106 and the platform when the winch 100 is mounted on a turntable 116 may be less than 24 inches, less than 18 inches, less than 12 inches, less than 10 inches, less than 8 inches, less than 6 inches, less than 4 inches, less than 2 inches, or less than 1 inch. Obviously, embodiments may be made at greater distances.

From the mounting surface, two side portions project vertically to support the winch drum 102. Each side portion may comprise a plurality of attachment points for securing other winch 100 components such as the bearing means 104 and/or the level wind mechanism 108 with the attachment means 112. The side portions are generally symmetrical but may individually vary in size and shape.

Depending on the maximum weight rating for the winch 100, the winch base 106 is formed from a high strength material of an appropriate thickness; in some embodiments, the winch base 106 is made from steel or a steel alloy material of a thickness of less or equal to ¼ inch, less than ½ inch, less than 1 inch, 1 to 2 inches, 2 to 4 inches, or in some cases, greater than 4 inches up to 10 inches in thickness. Furthermore, some embodiments include a winch base 106 which has certain portions of the winch base 106 at a select thickness and other portions at a different thickness.

### Bearing Means

The bearing means 104 is a load-bearing assembly and provides for the rotatable interface between the winch base 106 and the rotatable winch drum 102, allowing the winch drum 102 to move independently of the winch base 106 when the motor assembly 130 provides the means for rotation or when manipulated manually. The bearing means 104 supports the winch drum 102, and reduces the load bearing on the flanges 140.

The bearing means 104 is generally a bearing comprising a rotatable surface and a fixed surface. The rotatable surface most often attaches to the winch drum 102, and the fixed surface attaches to the winch base 106; in some embodiments, the rotatable surface attaches to the winch base 106, and the fixed surface attaches to the winch drum 102. In many embodiments, the bearing means 104 is attached to an axial end of the winch drum 102 by the flange 140. In other embodiments, the bearing means 104 is attached to an axial end of the winch drum 102 at another suitable position such as any point along the circumference of the winch drum 102 end.

Suitable bearings generally have a diameter capable of interfacing with the winch base 106 and the winch drum 102, a narrow profile for maintaining a compact winch footprint, and the ability to manage heavy loads or force reliably. Preferred bearings for some embodiments may additionally comprise an open internal diameter suitable for sliding the housing 128 comprising the motor assembly 130 through the center of the bearing into the winch drum 102. Any appropriate rotational means as used by one in the art includes roller bearings, angular contact bearings, ball bearings, spherical bearings, plain bearings, magnetic bearings, thin section bearings, thrust bearings, needle bearings, or the like. In some embodiments, the bearing means 104 uses one or more rolling element bearings such as ball bearings, and in particular slewing bearings. In further embodiments, the bearing means 104 is comprised of single row ball bearings which provide high rotational precision. Other embodiments use other types of ball bearings including two row ball bearings, cross roller bearings, or three row ball bearings as found to be appropriate considering the hauling criteria.

In many embodiments, the winch 100 comprises a bearing means 104 disposed on each axial end of the winch drum 102. In some embodiments, the winch 100 comprises one bearing means 104 disposed on one axial end of the winch drum 102.

The bearing means 104 is attached to the winch base 106 and to the winch drum 102 using bolts to allow secure attachment that can be removed for inspection or maintenance. In some embodiments, the bearing means 104 is secured by the means of welds, rivets, pins, nuts, threaded fasteners, or other means less removable than bolts.

### Level Wind Mechanism

In some embodiments of the winch 100 may also comprise a level wind mechanism 108 to assist the spooling (e.g., winding) of the cable evenly by providing tension to the cable and moving along the revolving axis of the winch drum 102 to carefully lay down the cable during retrieval or to unwind cable during deployment. In the absence of a level wind, the cable is more prone to bunch or cluster in uneven mounds along the length of the winch drum 102, creating tangles in the cable and hindering the hauling activities. In general, the winch 100 may utilize any level wind (e.g., line guide, cable guide, guide, spooler) or other suitable mechanism for laying down or winding cable along any shaped path of the axial length of the winch drum 102. In some embodiments, the winch 100 comprises the improved level wind mechanism 108, shown in FIG. 2.

One major aspect of the level wind mechanism 108 is the lightweight design due to the reduction in material. In conventional level wind constructions, a high strength beam assembly, employed at a frontal level position with the winch drum 102, is necessary in order to maintain cable organization under the torsional forces applied by the cable under load. The improved level wind mechanism 108 is reduced from two high strength bars down to a single lightweight beam 112, as shown in FIG. 1. The level wind mechanism 108 may be arranged to any appropriate position on the winch 100 to provide reliable cable spooling. In certain embodiments, the level wind mechanism 108 is positioned above the winch drum 102 and directs the wind of the cable from above the winch drum 102. In other embodiments, the level wind mechanism 108 is placed in a non-load bearing position on the winch 100. In another embodiment, the winch 100 does not comprise a level wind mechanism 108 and may use an alternative method for distributing cable.

The level wind mechanism 108 comprises a sheave 114, a carriage 118, a screw nut 120, a lead screw 122, a beam 124, a level wind motor assembly 110, and a level wind frame 126. As illustrated in FIG. 1, the beam 124 extends the length of the winch drum 102 and is supported by the level wind frame 126. The level wind frame 126 may be any structure capable of lending support for the rotating action of the sheave 114 and its level wind motor assembly 110. The sheave 114 is usually an open groove guide for the cable to sit in, supported on the carriage 118 with the carriage 118 disposed on the beam 124. The carriage 118, attached to the lead screw 122 by a screw nut 120 or other attachment means, is shiftably guided along the length of the beam 124 and driven by the lead screw 122.

The sliding motion of the carriage 118 and attached assembly is provided by the level wind motor assembly 110 rotating the guide beam 124. The level wind motor assembly 110 is often powered by an electric motor but may be any motor or any motive force including a DC electric motor, AC motor, hydraulic motor, manual crank, gear drive, chain drive, belt drive, hydraulic drive, winch drive, electric drive, etc. known in the art. Rotation of the guide beam 124 revolves the lead screw 122, resulting in the axial movement of the carriage 118 and sheave 114 assembly along the length of the winch drum 102.

The level wind mechanism 108 is typically comprised of metal or mechanical grade plastic but may also be constructed from other suitable materials or composites. Furthermore, the level wind components may be formed of any shape and size such as the sheave 114 to accommodate various cable types. In some embodiments, one or more of the components of the level wind mechanism 108 is coated in a protective coating (such as one described below) for increased resistance to the environment.

The level wind mechanism 108 may be operated by the controller or by a separate means of operation. Additional sensors may be added to the level wind mechanism 108 to assist guidance of the sheave 114 and/or cable such as a sheave sensor (e.g., motion sensor) for monitoring upward and downward motion in a marine setting, load sensors for cable tension control, or the like.

### Controller

The controller controls the various operations of the winch 100 by regulation of the motor assembly 130 which in one or more embodiments may include on or more of the following: activation of rotation, stopping of rotation, forward or reverse rotation direction, speed of rotation, and other functions. In some embodiments, the controller is engaged with the winch 100 power supply and provides a signal(s) to the motor assembly 130 to activate the motor 132 and provides the motor assembly 130 with power to rotate the winch drum 102 in the desired direction to raise or lower the cabled load. In other embodiments, the controller is engaged with the winch motor assembly 130 by any suitable means.

The controller comprises an operator station and a motor control means, and in some embodiments, an additional remote control device to operate the winch 100 from a separate position on the platform. The controller may comprise a Programmable Logic Controller (PLC), a touch screen, a monitor, a plurality of buttons, an emergency stop, etc., although any controller found suitable by one skilled in the art for the operation of the winch 100 may be employed. In some embodiments, the controller is waterproof.

Generally, the operator station transmits signals to the motor control means via a connection to the motor assembly 130 that may be wired or wireless. The operator station is capable of transmitting commands such as start and stop of rotation in either the forward direction and the reverse direction and the speed at which the winch drum 102 turns. The controller may comprise additional features including an emergency stop function or monitoring of parameters such as cable position, cable overspill, cable slack, level wind control, etc.

The controller may be affixed to the winch 100 (“at winch” controller) or may be plugged into the winch 100 (“local” controller) to allow the operator to stand at a nearby location. In some embodiments, the winch 100 is operated by a handheld controller (“remote” controller) either through a wired or wireless (e.g., Bluetooth, optical, acoustic, or other suitable means) connection. In some embodiments, the controller is a portable unit which can be plugged/unplugged into the winch 100.

In some embodiments, additional components are used with the controller such as sensors for cable tension, cable length deployed, cable speed, cable angle, cable slippage, motion (e.g., vertical heave, sideways motion, heave sensor), and other similar or like sensors.

### Quick Removal Means

The winch 100 comprises the means to easily access, remove, and exchange the motor assembly 130 and/or drive means 136 disposed within the winch drum 102 via the quick removal means. The quick removal means allows one or more components disposed within the winch drum 102 to be disengaged by any suitable manner without dismantling the entirety (e.g., removing the winch drum 102 from the winch base 106, removing the level wind 108, detaching the winch 100 from the platform or turntable 116, disconnecting the bearing means 104, etc.) of the winch 100. The motor assembly 130 held center by the housing 128 is disengaged and removed by sliding the housing 128 through one axial end of the winch drum 102. In some embodiments, the quick removal means involves detaching the drum engagement means 138 from the winch drum 102, allowing the entire assembly comprising the drive means 136, the motor assembly 130, and the housing 128 to exit the winch drum 102. In other embodiments, the drive shaft 139 disengages the drum engagement means 138 to permit the drive shaft 138, the motor assembly 130, and the housing 128 to be removed from the drum 102. In other embodiments, the drive shaft 139 disengages from the gearbox 134, allowing the gearbox 134, the motor 132, and the housing 128 to exit the winch drum 102. In other embodiments, the motor 132 is disengaged from the gearbox 134, and only the motor 132 and the housing 128 are removed.

### Winch Materials

In instances where the winch 100 is made for operation in the marine or an otherwise wet environment, the winch 100 is most often fabricated from materials capable to resist corrosion and oxidation while providing the strength and fatigue properties to resist wear and tear as subjected to under the demands of heavy cabled loads.

The winch 100, including components such as the winch drum 102, the winch base 106, the level wind mechanism 108, the housing 128, and other components which bear weight are comprised of one or more high strength structural materials capable of resisting deformation under applied force. Although several types of material may be suitable for construction, the winch 100 components are generally fabricated from metal, preferably steel, stainless steel, steel alloys, titanium, cast iron, copper, mechanical grade plastics like thermoplastics, fiberglass, composite materials, or any combination thereof. In many embodiments, the winch drum 102, the winch base 106, and the housing 128 are manufactured from metal, and more preferably steel, of a suitable thickness and strength for withstanding the forces applied thereto. In some embodiments, some or all of winch 100 components are built using aluminum or aluminum alloy to greatly reduce the weight of the winch 100 and provide a more portable version suitable for lighter hauling tasks.

Various components of the winch, including the winch drum 102, the winch base 106, the attachment means 112, the housing 128, or other suitable parts, may be laminated in a protective coating to increase resistance to corrosion or decay from the surrounding environment. In some embodiments, components of the winch 100 are furnished with a suitable coating such as zinc (e.g., inorganic zinc), chrome plating, paint, epoxies (e.g., ceramic epoxy), polymers (e.g., fluoropolymer, polytetrafluoroethylene (PTFE), polyphenylene sulfide (PPS), ethylene propylene, polyurethane, polyvinylidene fluoride (PVDF), ethylene chlorotrifluoroethylene (ECTFE)), paint (e.g., molybdenum disulfide, phenolic, phosphate) or other coatings known in the art. In other embodiments, metal components of the winch 100 are composed of materials which have been galvanized (e.g., hot-dipped galvanized, electrogalvanized) or chrome plated.

In general, the winch components are assembled and attached using attachment means 112 (as illustrated in FIG. 3) such as fasteners including but not limited to nuts and bolts, pins, grooves, welds, rivets, threaded fasteners, or other suitable fittings. In some embodiments, such attachments means 112 are also coated with a corrosion-resistant coating or galvanized. The size or length of the attachment means 112 varies depending on the thickness of the material and washers, if needed, for assembly. In yet other alternate embodiments, certain components may be welded together when they do not require independent motion from each other.

### Cable

The winch 100 may be adapted to use a plurality of cables or ropes of various materials and breaking strengths depending on the hauling load. Suitable cables or lines include rope, strap, cord, tube, wire, chain. Further examples include but are not limited to wire (e.g., metal, steel, stainless steel, copper, titanium), synthetic rope (e.g., polyester, polyethylene, thermoplastics, polytetrafluoroethylene, and/or nylon ropes), aramid fiber, liquid crystal polymer fiber, Polyethylene terephthalate (PET) fiber, single strand line, multi-strand (e.g., weave) line, fiber optic (e.g., light guide), 0.322″ CTD cable, or any other appropriate cable for use with winches or for hauling purposes. In one embodiment, the winch 100 employs a 3×19 (3 strands, 19 wires per strand) wire rope.

In some cases, the cable is coated or jacketed for additional break resistance against abrasion, salt, water, marine biofouling, or chemical corrosion such as from oxidation. Such protective coatings or treatments include galvanized coating with zinc, a jacket (e.g., braided jacket, plastic jacket, extruded plastic jacket, combination material jacket), lubrication, polyurethane, resin, heat treatment, or any appropriate method to minimize wear and tensile fatigue.

Any length of cable may be used on the winch 100 which is dependent on the diameter and length of the winch drum 102 up to 50,000 feet or more. In certain embodiments, the winch 100 comprises 100 feet, up to 500 feet, up to 1,000 feet, 1,000 to 5,000 feet, 5,000 to 10,000 feet, 20,000 feet, 30,000 feet, or more of cable wrapped on the winch drum 102. In some embodiments, the cable is rated for ocean bottom exploration and made of wire rated for about 100,000 psi, 200,000 psi, or 300,000 psi or more.

Cable sizes include less than ⅛ inch, ¼ inch, 7/32 inch, 5/16 inch, ⅜ inch, 5/16 inch, 7/16 inch, ½ inch, ⅝ inch, ¾ inch, ⅞ inch, 1 inch, 1⅛ inches, 1¼ inches, 1 ⅜ inches diameter, 2 inch or more, or any suitable cable capable of winding about the winch drum 102. Cables may be rated for working loads less than 100 lbs, up to 1,000 lbs, up to 2,000 lbs, up to 5,000 lbs, up to 10,000 lbs, and up to 50,000 lbs, to or greater than 100,000 lbs or more.

### Optional Turntable

The winch 100 may be directly mounted to a platform for a fixed position or may be attached to an additional mounting plate or structure such as a turntable 116. An exemplary turntable 116 is found in the U.S. Provisional Patent Application No. 62/090,672 “Portable Turntable and Winch” which allows the winch 100 to be easily manually rotated in any direction or locked to a fixed position. As shown in FIGS. 2 and 3, the light weight, compact winch 100 is easily mounted on the turntable 116 using suitable attachment means 112 to provide precise angular position for hauling purposes; the winch 100 and turntable 116 can also be easily removed for repositioning to another area on the platform. The winch 100 may be designed for compatibility with a plurality of other mounting plates, structures, or turntables 116 known to those skilled in the art.

### Methods of Use

The winch 100 is generally operated as follows. The winch 100 is secured to a platform (e.g., deck), directly or to a turntable 116 mounting base by attachment means 112 and mounted to the platform relative to where the winch operation will occur. Upon suitable rigging of the cable and the load for deployment or retrieval, the winch 100 is attached to a power source and in communication with the controller by the operator.

As the operator employs the controller, signals are provided to the motor assembly 130 (or other suitable component) to actuate the winching mechanism for hauling, deploying, supporting etc. (depending on the application), causing the winch drum 102 to rotate in a forward or reverse direction as determined by the operator. Power is provided to the motor assembly 130 which is translated into rotational motion via the drive means 136 coupling the drum engagement means 138 to turn the winch drum 102. The turning of the winch drum 102 winds the cable on or off of the winch drum 102 in a speed-controlled manner which is determined by the controller or by a pre-set speed. After a series of rotations, the attached load is deployed, retrieved, or supported from the platform. The repetitive turning of the winch drum 102 for retrieval winds the cable back onto the winch drum 102 in an evenly distributed manner via the level wind mechanism 108 (or other method), returning the cable back to its storage position.

The level wind mechanism 108 guides the cable onto the winch drum 102 through the sheave 114 to evenly spool the cable about the revolving axis and equally across the axial length of the winch drum 102. The level wind mechanism 108 may also lead the cable from the winch drum 102 over to additional sheaves 114 or other rigging components set up on the platform for the deployment of the attached load.

When the winch 100 in not in operation, the motor brake or similar means prevents the unnecessary rotation of the winch drum 102.

In instances where the winch 100 is desired at another position on the platform, the winch 100 may be uninstalled by removing the single lightweight beam 112 from the winch base 106 or from the turntable 116. The lightweight winch 100 may then be moved and re-bolted to another selected position on the platform. In some embodiments, the winch 100 is repositioned by rotation on the turntable 116.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The compositions, components, and functions can be combined in various combinations and permutations, to achieve a desired result. For example, all materials for components (including materials not necessarily previously described) that are suitable for the application are considered within the scope of the invention. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith.

For the purpose of understanding the Compact Winch apparatus, references are made in the text to exemplary embodiments of a Compact Winch, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the act of hoisting, lifting, lowering, and supporting with a winch may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

### Universal Level Wind

The level wind aspect of the present invention may be further improved upon in some embodiments such that it may be applied to other winches than the winch embodiments described herein. The universal level wind system 200 and method of using the same, will be described presently. The level wind system 200 includes a hollow, elongate support member, a leadscrew, a guide substantially supported by the support member and adapted to (i) move along the support member, (ii) accept a tension member and a force from that tension member, and (iii) transfer the tension member's force to the support member, a motor connected to the leadscrew and adapted to apply a motive force to the leadscrew, and a connection means interconnecting the guide and leadscrew, and adapted to move along the leadscrew along the leadscrew's longitudinal axis in response to the motor's applied force.

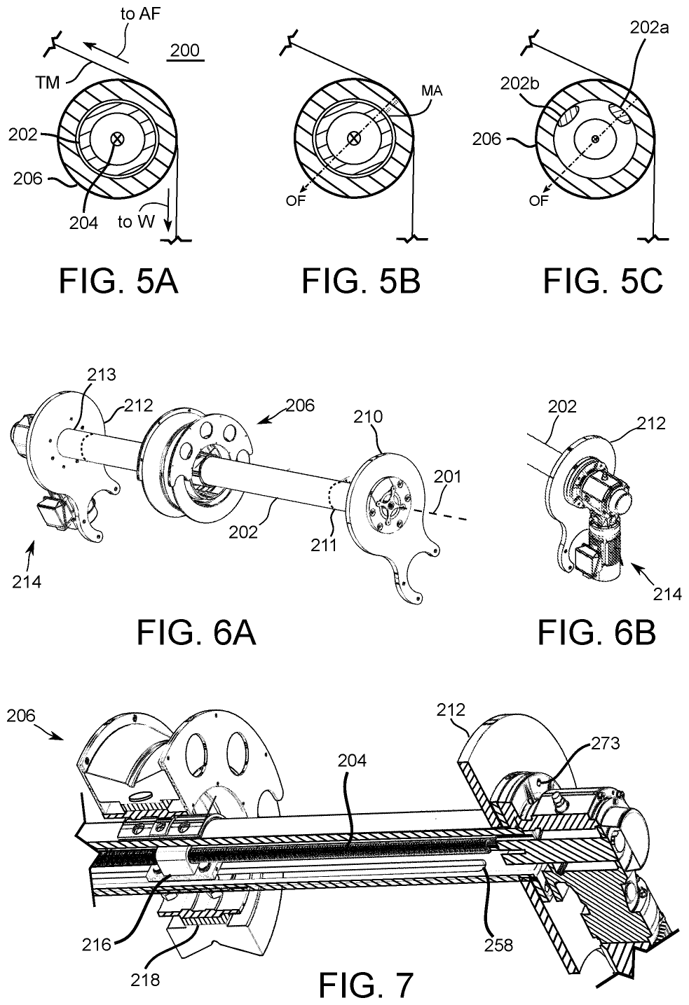

FIGS. 5A and 5B are side view cross-section illustrations of the currently preferred embodiment, having a level wind system 200 comprising a single support member 202, a leadscrew 204, and a guide 206, all having a common central axis 201. A shuttle 226 connects leadscrew 204 to guide 206. The guide 206 is adapted to accept a tension member TM, which typically connects to a winch W and to another object AF, for example an A-frame. The tension member TM will typically experience a force OF as the winch is operated. The tension member's force is transferred onto the guide 206 and then the load-bearing support 202. The resulting overall force OF applied by the tension member TM to the support member 202 is illustrated in FIG. 5B, and is only in one dimension, towards the center of the guide 206, and therefore towards the central axis 201. Due to the system's single, interior support 202, the present invention greatly simplifies the structure of the forces applied to the system 200. Furthermore, the moment arm MA, the distance from the tension member TM to the support 202 is smaller in the present invention as compared to the art. The moment arm MA is depicted as a thick, grey dashed line in FIG. 5B, offset slightly for clarity from the line depicting the overall force OF (black dash-dot arrowed line) from the tension member TM onto the system 200.

The inventive system described herein is contrasted by level wind systems that have a plurality of supports, often two, adjacent to the sheave (i.e., the disclosed guide), and linked to the sheave's axis of rotation by a connector (i.e., the disclosed shuttle). The tension member applies force to the sheave, the connector and the plurality of supports. Due to the location and the fact that there is more than one support, the force from the tension member is applied in a two dimensional manner, in the x and y planes. The cumulative force then acts on each support in a rotational manner.

FIGS. 6A and 6B illustrate two views of one embodiment of the present invention. Level wind system 200, has a hollow support 202 supporting guide 206. Two flanges 210, 222 are located on end 221 and 223 of support 202 and are configured to connect the system 200 to the winch W (not pictured for clarity, see FIG. 12). The flanges create separation between system 200 and the winch W, enabling the guide 206 to move parallel to the winch drum WD, prevent guide 206 from leaving the support 202, support the system 200, and enable movement of the entire system out of place, for winch movement and maintenance.

FIG. 7 illustrates a partial cross-sectional view of the currently preferred embodiment. Leadscrew 204 is seen internal to the single hollow support 202 and connected to a motor 224. The motor 224 is configured to affect the leadscrew 204, enabling the guide 206 to move along the support 202. In the currently preferred embodiment, the motor 224 is configured to rotate the leadscrew 204 about its longitudinal axis. A shuttle 226, or connection means (e.g., a nut) is provided inside support 202 and placed onto leadscrew 204, and further connects to guide 206. Shuttle 226 translates the movement of the leadscrew 204 into linear motion, propelling guide 206 along support 202. In the currently preferred embodiment, leadscrew 204, shuttle 226, support 202, and guide 206 all share a common center axis or point. Shuttle 226 on leadscrew 204 imparts the often rotational force of the leadscrew 204 to the guide 206, moving guide 206 along (back and forth) support 202. Also shown in FIG. 7 is a load-transferring mechanism 228, referred herein as bearing 228 that allows for a first, fixed portion 220 and a freely-movable second portion 222 of guide 206.

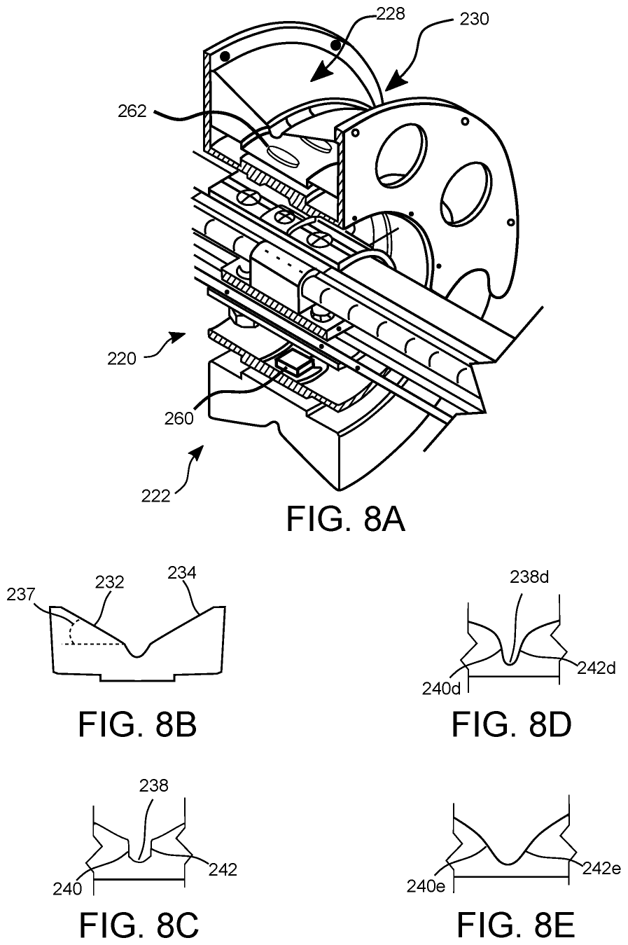

FIG. 8A illustrates a closer view of guide 206 shown in FIG. 7, showing the first portion 220 and the second portion 222. The present invention provides for at least one fixed side-wall member guard 224 (referred herein simply as a guard) typically attached to the first portion 220. The second portion 222 further comprises a receptacle 228, typically V- or U-shaped, for holding and constraining the tension member TM to be sent to or coming from the winch drum WD and another destination (e.g., A-frame) AF. FIGS. 8B-8D show the receptacle 228 in detail and from differing embodiments, each embodiment with different geometry.

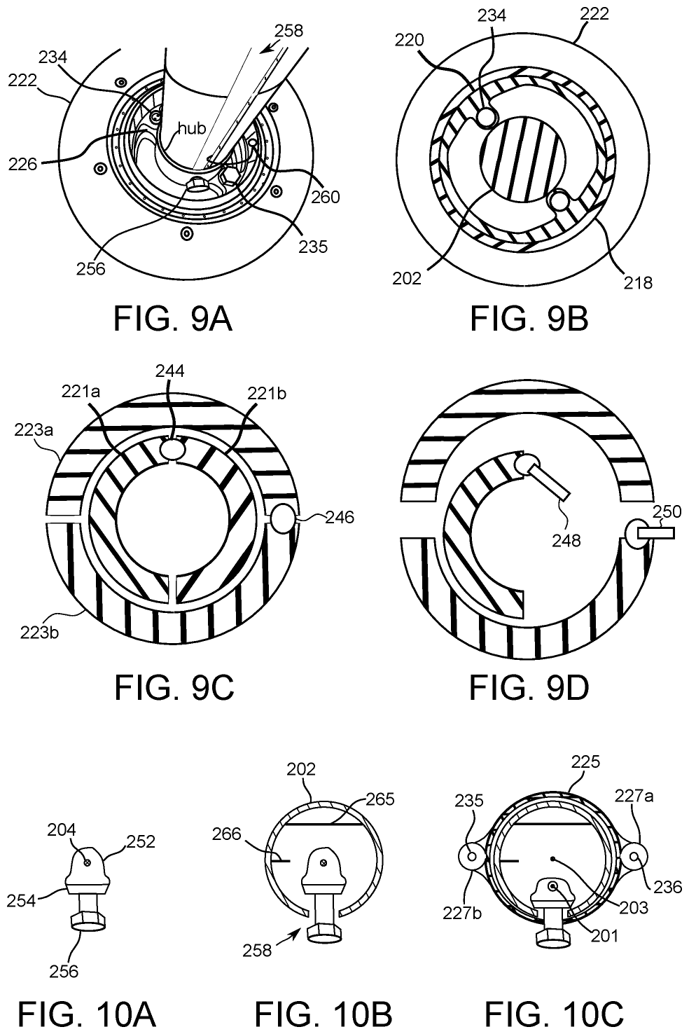

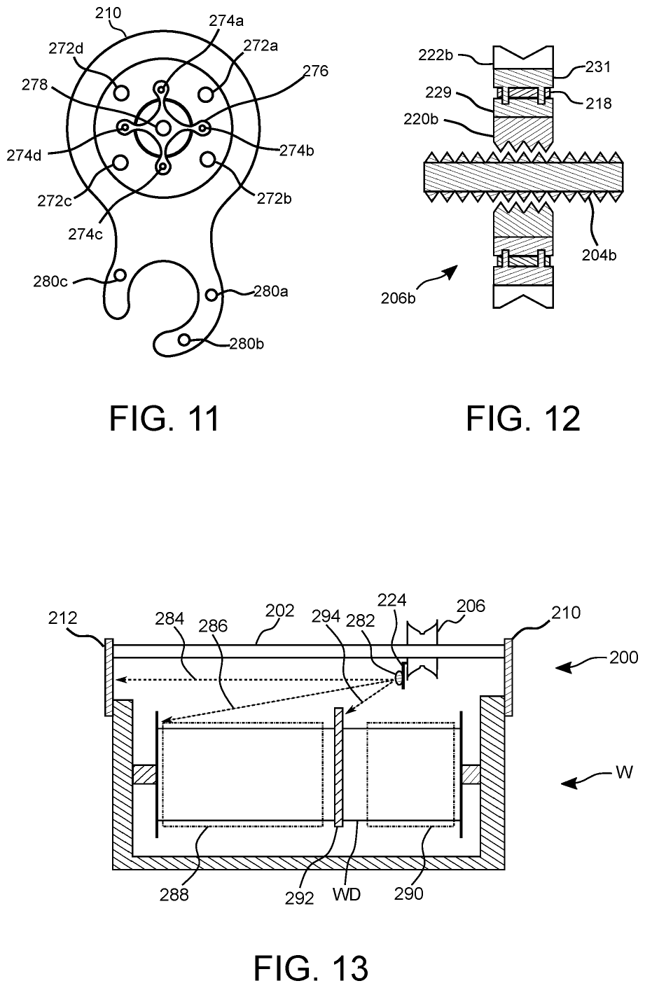

FIGS. 9A-9D continue illustrating components of guide 206 according to the present invention. The first portion 220 can be further divided into a hub 225 and carriage 226. Carriage 226 may accommodate a load sensor 234 and is connected to the hub with the load sensor 234 and bolt 235. Carriage 226 is connected to the second portion 222 by bearing 228. FIGS. 9C and 9D illustrate a guide 206 made up of smaller sections. FIG. 10A illustrates the components interior of guide 206, showing the shuttle 226, sled 254, and drive pin 256; while FIGS. 10B and 10C show how these components interact with additional components, including support 202, shelves 265, 266 and the hub components, including hub ear 227, bolt 235 and load sensor 236. FIG. 11 illustrates one example of the various attachment points of a flange 210 of a given embodiment. And FIG. 12 illustrates an overview of a winch apparatus W having one embodiment of the present invention, the embodiment further having a position sensor 282, and winch drum practitioner 292, which along with a controller 264 enable the system 200 to partition the winch drum WD into a first and second partition 288, and 290.

### Common Axes

The currently preferred embodiment achieves a reduction of components over currently known level wind systems by sharing a common central axis 201 upon which several of the components are centered (i.e., coaxial). The central axis 201 allow for a single support member 202 to form the structure upon which guide 206 moves along. The central axis 201 can also be thought of as a coaxial axis, where two or more components in the level wind system 200 share a common axis, here the longitudinal axis. Thus, in the currently preferred embodiment, at least guide 206, and support 202 form a concentric or substantially concentric, three dimensional form. In other embodiments central axis 201 is not shared by all components. A second longitudinal axis 203 may be defined that is shared by one or more components. For example, as illustrated in FIG. 10C, guide 206 (not shown, instead hub 225 is shown) and support 202 are coaxial on axis 203, while leadscrew defines axis 201.

### Guide

The present invention provides a guide mechanism 206 that places the tension member TM in proper alignment and condition for placement on the winch drum WD and accepts the forces experienced by the tension member TM to support 202. Unlike guides used in the art, the present guide preferably is coaxial with the support 202, and in some cases the leadscrew 204. The central axis 201 greatly reduces the moment arm MA forces applied to the guide 206 from the tension member TM as the system is operated. Reduced moment arm MA forces reduce the risk of damage to the system during normal operation (e.g., wear and tear) as well as reduce the risk of level wind system 200 and winch W structural damage (e.g., a bent support 202) or collapse in the advent of a tangled or fouled tension member TM. Reduction of the moment arm MA forces further enables the reliance on a single support member 202, as opposed to two or more supports used in the art.

The guide 206 preferably is supported by support 202, and preferably rests substantially on support 202. Typically guide 206 moves along support 202, moving from one end 221 of the support 202 to another end 223, almost always moving end to end of the support 202 multiple times during system operation. The driving force applied to guide 206 will be discussed in more detail below.

### First Portion

In one embodiment of the current invention, the guide 206 is divided into a first portion 220 and second portion 222. The first portion 220 is connected to the shuttle 226 and is substantially supported by (e.g., rests on) on support 202. The first portion 220 receives the lateral force provided from shuttle 226 translated from leadscrew 204, resulting in a lateral movement of the entire guide 206 along support 202. The lateral force is defined as a force in the direction of the central axis 201, substantially parallel to the winch drum WD, and along the length of support 202. The first portion 220 is not rotatable but contains a bearing mechanism 228 on its outer circumferential surface, that is, the surface of the first portion 220 facing or between the first and second portions. Bearing mechanism 228 allows the second portion 222 to freely rotate without movement of the first portion 220 or rotational force transfer to the first portion 220.

The first portion 220, illustrated in FIGS. 9A-9D, can be further divided into a hub 225 and carriage 226, which are fixedly attached to one another. In one embodiment, two attachment points are present, and a bolt 235 and a load sensing mechanism 236, referred herein as the load sensor, connect the hub 225 to carriage 226. In the embodiment illustrated in FIGS. 9A-9B and 10C, hub 225 has physical protrusions accommodating the connection referred herein as hub ears 227a and 227b.

A guide 206 with a single support 202 also enables direct load force measurement of the tension member TM. The load sensor 236, often a load pin known in the art, receives the forces placed on the second portion 222 by the tension member TM. A load sensor 236 located within the guide 206 provides a novel, and much more accurate load measurement ability over the current method of load calculations based on entire winch assembly W weight.

### Second Portion

In the currently preferred embodiment, the second portion 222 of guide 206 is configured to rotate freely about the first portion 220, and most often, about the common central axis 201. Rotation ability is provided by bearing 228 between the first and second portions. In the currently preferred embodiment, bearing 228 is a ring bearing as known in the art, preferably a slewing ring bearing. In another embodiment, bearing 228 is a roller bearing. A receptacle 228 accepts and guides the tension member TM through the system 200. In addition, receptacle 228 receives any forces experienced by the tension member TM. The received forces from the tension member TM are transferred to receptacle 108, second portion 222 overall, first portion 220 and finally to support 202.

The receptacle 228 has a groove 230, and at least two side walls 232, 234. Several embodiments of the receptacle 228 are shown in more detail in FIGS. 8B-8E. Preferably, the receptacle 228 has slopped side walls 232, 234, such that when equipment attached to or part of tension member passes over the guide 206, the equipment does not catch (e.g., mooring line shackles). Side walls 232, 234 may be any suitable geometry, typically within angle 237 of 30 degrees to 75 degrees above a line parallel with the central axis. Between side walls 232, 234 and typically in the center of receptacle 228 and guide 206 overall, is grove 230. The grove 230 is adapted to accept, or receive, the tension member TM directly, and preferably to restrain it from moving left or right onto a side wall. The grove 230 is of sufficient width to accept at least one sized (i.e., diameter) of tension member TM. Often the grove 230, is of sufficient width to accept several diameters of tension member TM. Most often grove 230 is tapered, being wider at the apex (where it meets side walls 232, 234) than at the base 238. In some embodiments, the groove is ‘U’ shaped with a rounded base 238 and substantially straight sides 240, 242, as illustrated in FIG. 8C. In the currently preferred embodiment, the base 238d of groove 230 is ‘U’ shaped, but sides 240d, 242d of the groove are more gently angled away from the vertical, that is shaped as the sides of a ‘V’ to allow the use of more than one size of tension member TM with one guide 206, as illustrated in FIG. 8D. An alternative to the currently preferred embodiment is illustrated in FIG. 8E, where sides 240e and 242e are sloped closer to 45 degrees.

Typically, receptacle 228 is about 3 to 8 inches wide. In the currently preferred embodiment, receptacle 228 is 5 inches wide, with a height of 0.5 to 5 inches, preferably 2 inches in height. The shallow nature (larger width than height) of receptacle 228 of the currently preferred embodiment provides system 200 to accept variable diameter tension member TM and attached objects without damage to or fouling of the system 200. Examples of objects attached to a tension member TM that this system 200 is designed to accept without stoppage are the Ocean Observatories Initiative (OOI) Pioneer Offshore Moorings line objects, including shackles, swivels, bushings, and sling links.

The guide 206 of the present invention is further interchangeable. The size of the groove 230, receptacle 228 and overall guide 206 is best suited for a single size, or at best, three sizes of tension member TM. Therefore, it is within the scope of the present invention for a plurality of guides, each guide sized for a size or sizes of tension member TM. To remove a guide 206, the currently preferred embodiment further comprises a guide 206 constructed of at least two sections. Both the first portion 220 and second portion 222 may be separated into sections, typically halves, and a mechanical key is used to lock and unlock the sections. The first portion 220 may be assembled from at least two sections, a first section 221a a second section 221b. Second portion 222 may also be assembled from at least two sections, a third section 223a and a fourth section 223b. A locking mechanism is located on or between sections and adapted to engage the adjacent section. As illustrated in FIG. 9C, lock 244 is on or between first section 221a and second section 221b and upon use of key 248 engages and disengages the sections. Likewise lock 246 is on or between third section 223a and fourth section 223b and upon use of key 250 engages these sections. In some embodiments, locks 244 and 246 use unique keys, while in some embodiments, locks 244 and 246 use an interchangeable key. Some, less preferred embodiments may have more than two sections for one or both of the first and second portions, each section having a lock and key to constrain the sections in place.

To remove a removable guide 206, first any sensors located in the guide 206 are disconnected, then a key 250 is inserted into the second portion's locking mechanism 246, the lock 246 is unlocked and the second portion is removed in its two sections. The key (either key 248 or 250) is entered into first portion 220 and that portion is unlocked and removed in a similar manner.

In further embodiments, guide 206 is not sectioned, but is removed by unbolting the drive pin 256 of shuttle 226, allowing guide 206 to move freely independent of leadscrew 204. Any sensors connected to the guide 206 are disconnected, and then a flange, typically the first flange 210 (without motor 224) is next unbolted and removed. The guide 206 is then slid off support 202 and a new guide, adapted for a differently sized tension member TM, is loaded onto the support member 202.

In additional embodiments, the guide 206 and the second portion 222 may comprise differently shaped means. In some embodiments, the second portion 222 is ‘V’ shaped with two rigid structures attached to the first portion 220. In other embodiments, the second portion 222 is selected from the list of at least two horizontal rollers, at least two vertical rollers, at least two cogs, an eyelet, and a pulley.

### Shuttle

The invention provides a mechanism to transfer and convert the movement, or force, of leadscrew 204 into lateral movement of the guide; this mechanism is referred herein as the shuttle 226. In the currently preferred embodiment, shuttle 226 comprises a nut 226 that encompasses leadscrew 204 located substantially at guide 206. A drive pin 256 securely, but reversibly fastens nut 226 to hub 225. Shuttle 226 moves laterally along leadscrew 204 as it is actuated (e.g., turned by the motor in the preferred embodiment). In the currently preferred embodiment, shuttle 226 is fitted such that it passes through an opening 258 in the support member 202. In the embodiment illustrated in FIGS. 10A-10C, nut 226 comprises an additional sled section 254, securely bolted to nut 226. However, in other embodiments, nut 226 and sled 254 are a single physical piece. In other embodiments, shuttle 226 comprises a magnetic connection and the supporting member 202 has no physical opening, instead first portion 220, or guide hub 225 is connected to shuttle 226 by way of electromagnetic or magnetic forces.

### Guide Movement Sensor

An additional feature of the present invention is the direct measurement of the movement of guide 206. Current winch assemblies W use computational calculations to estimate the amount of tension member TM moved, and therefore the amount of time needed to run the winch before the target depth has been reached during deployment (or amount of tension member TM spooled out). Placing a piece of equipment (e.g., a sensor) or other object at a precise depth can be critical for a mission, especially when that location is near a floor (e.g., seafloor or mine shaft bottom). The present invention provides a guide movement sensor 260, referred herein as the metering sensor, typically within or on guide 206. The metering sensor 260 may comprise any suitable sensing mechanism as known in the art.

In the currently preferred embodiment, the metering sensor 260 comprises a hull effect sensor located on or within the first portion 220. Within the second portion 222 is a readout 262, typically set of magnets, preferably 10 to 20 magnets. The magnets may be in any section of the rotating second portion 222, but most often are located underneath groove 230, in the midpoint of the width of guide 206, as illustrated in FIG. 8A. Metering sensor 260 may be located in any section of the fixed first portion 220, most often at the midpoint of the carriage 226, immediately opposite the set of readout 262 magnets in the second portion 222. The hull effect sensor 260 detects the readout 262 magnets as they pass. The sensor is then connected to a digital control device, referred herein as the controller 264, which calculates guide 206 rotational rate by the rate at which the magnets are detected. In some embodiments, the hull effect sensor is connected to the controller 264 by a wire. In other embodiments, the hull effect sensor wirelessly connects to the controller 264. The present invention, with the metering sensor 260 and load sensor 234 accurately monitors tension member TM metering. Furthermore, with the rotation of the guide 206 being known, it can be compared with the rotation of the winch drum WD. If the drum WD and guide 206 rotate out of the proper ratio, the system can be shut off automatically, protecting against simple to catastrophic faults.

### Support Member

The presently described inventive system places forces experienced by tension member TM onto a single support member 202. Furthermore, the support 202 and leadscrew 204 are substantially interior to guide 206. In the currently preferred embodiment, support 202 is a hollow, coaxial (to at least leadscrew 204) cylinder-shaped member. In this arrangement, guide 206 is substantially supported by a single support 202 and that support is sufficient to withstand the forces applied guide 206 by tension member TM. The support member 202 most often comprises a hollow interior, enabling leadscrew 204 to fit inside and optionally, allows it to have the same common central axis 201 (coaxial) of support member 202 and guide 206. In embodiments that support 202 is not coaxial with leadscrew 204, support 202 has a second longitudinal axis 203. This axis may be coaxial with other components of system 200, most often guide 206, as illustrated by FIG. 10C. By making the support member hollow, the system if further simplified by necessitating only two attachment points of support 202 to winch W, typically by two supporting flanges 210, 221, and reducing the overall size of the system 200. Support 202 is most often elongate, that is longer in one dimension (i.e., length) than any other dimension (i.e., width and height). An elongate support 202 can be thought of as having end portions 221 and 223 (denoted in FIG. 6A as dotted lines on support 202). Most often ends 221 and 223 are continuous and identical to the remaining portion of support 202. Ends 221 and 223 are ideal sections for attachment of flanges 210, 221 or direct attachment to winch W.

In some embodiments, support member 202 further comprises at least one opening 258 along at least a portion of the support member's longitudinal length. Preferably, opening 258 provides the physical space for shuttle 226 to connect to the first portion 220 of guide 206 to the leadscrew 204. In some embodiments, support 202 further comprises at least one shelf 265, as illustrated in FIGS. 10B and 10C, internal to support 202, but not interfering with the movement of other components (e.g., leadscrew 204 or shuttle 226). Shelves 265 and 266 enable the wiring of sensors, lights, or other electronic devices throughout the system 200, as well as to guide 206. Typically shelf 265 enables wires to pass from one end (i.e., where flange 210 attaches) to another, and shelf 266 enables connections to moving shuttle 226 and guide 206.

In other, less preferred embodiments, support 202 is not hollow, and comprises a solid piece, or pieces interior to guide 206. These embodiments may comprise additional support members, as long as they are interior to guide 206. The at least first support member 202a receives the force applied to guide 206 by tension member TM. As illustrated in FIG. 5C, the cumulative tension member TM force is applied towards the center of guide 206 and first support member 202a receives the force. A second support member 202b is shown in FIG. 5C and is interior to guide 206.

In the currently preferred embodiment, support 202 comprises a straight physical piece that is substantially parallel to the winch drum WD. In some embodiments, support 202 and winch drum WD are exactly parallel or almost exactly parallel, such that the distance between the leadscrew and the winch drum does not change along the length of the longitudinal axis.

In the currently preferred embodiment, leadscrew 204 is located substantially within (i.e., interior to) support 202, but leadscrew 204 is not entirely encompassed, an elongate opening 258 is provided to act as a pass through, accepts shuttle 226. This opening 258 exists along the length of support 202. In further embodiments, support 202 only partially encompasses the leadscrew, surrounding leadscrew 204 by at least 25% to 99%.

The level wind system 200 disclosed herein comprises at least one support 202, and the at least one support 202 is interior to guide 206. In additional embodiments, the system further comprises at least a second support member 202b, the additional second support 202b is also interior to the guide, as illustrated in FIG. 5C. The support members are all interior to guide 206, and while are separate physical structures, they comprise a defined, interior (to the guide) support mechanism, where at least one member receives the force from the tension member TM. The tension member force is transferred from the tension member TM by guide 206 to at least one support member 202 and, if present the at least second support member 202b.

### Leadscrew

The present level winding system 200 relies on a leadscrew mechanism 204 to move guide 206, across support 202, most often parallel to the drum WD. The leadscrew 204 may be any suitable mechanism as known in the art. In the currently preferred embodiment, leadscrew 204 is selected from the commercially available screws, for example an acme screw. The leadscrew 204 is connected to motor 224, such that motor 224 applies a force to leadscrew 204. Typically, leadscrew 204 is rotated to move shuttle 226 and guide 206 along support 202. In these cases, motor 224 turns the leadscrew 204. Typically, the selected leadscrew 204 fits at least substantially within the hollow support 202 with enough clearance for the nut 226 to move freely as motor 224 turns the leadscrew 204. In the currently preferred embodiment, leadscrew 204 is configured to rotate about its longitudinal axis. In the currently preferred embodiment, the leadscrew's longitudinal axis is also the common central axis 201. The leadscrew 204 may be coaxial with guide 206, or coaxial with support 202, as illustrated in FIGS. 5C and 5A, respectively. Alternatively, leadscrew 204 may not be coaxial, having axis 201 while support and guide are coaxial, having axis 203, as illustrated in FIG. 10C.

In many embodiments, leadscrew 204 is configured to reverse direction of the attached shuttle 226 (and therefore guide 206) by reversing the direction motor 224 is driven. In other embodiments, leadscrew 204 has a cut pattern such that shuttle 226 reverses at each end of the leadscrew because of the cut. In further embodiments, leadscrew 204 comprises a power screw, as known in the art. In still further embodiments, leadscrew 204 comprises a hydraulic or pneumatic actuator, extending and retracting to move shuttle 226. In these embodiments, leadscrew 204 does not rotate and the force applied to shuttle 226 is linear, not rotational.

In some embodiments, the support 202 and leadscrew 204 are combined, as illustrated in FIG. 13. In these embodiments the leadscrew is load-supporting and additional supports exist, and the combined load-supporting (i.e., load-bearing) leadscrew 208B interacts directly with guide 2010B. The guide 2010B substantially rests on, and transfers forces onto the load-supporting leadscrew 204. Guide 2010B in these embodiments further incorporates the shuttle 226 physically into the first portion 220b and has a transmission mechanism 229 that enables the guide's movement along the leadscrew 208B from one end to the other at the proper pace, in accordance with the selected tension member TM diameter. The transmission mechanism 229 may be any suitable mechanism as known in the art, including a worm gear, a worm drive, a spur gear, or the like. The load-supporting leadscrew 208B may be any suitable actuating mechanism, typically an acme screw or a diamond screw as known in the art. The incorporation of shuttle 226 into first portion 220b, most often includes machining teeth or other grasping mechanism, as depicted in FIG. 12 into first portion 220b such that it will engage with the load-supporting leadscrew 208B. Further, a mechanical metering mechanism 231 may be incorporated into the second portion 222b to propel guide 2010B along leadscrew 208B. In these embodiments the mechanical metering mechanism 231 may be in addition to bearing 228, or in replacement of bearing 228. In addition, this mechanical metering mechanism 231 may connect to controller 264 and report tension member TM metering.

### Flanges

The present invention provides for at least two connections, referred as flanges 210, 221, to support at least support member 202. Typically, the flanges further support leadscrew 204 and motor 224. Additionally, the flanges cap the support 202 and at least one end of the leadscrew 204. The flanges are bolted, or otherwise rigidly fixed to the winch W, such that the level wind system 200 is in a place that allows the tension member TM to be drawn off the drum WD over the guide 206 and to the object AF. In the currently preferred embodiment, flanges 210, 221 position system 200 above the winch assembly W. Preferably, flanges 210, 221 are rigidly and reversibly attached to the winch W, allowing for large forces to be applied to system 200, but still ensuring the ability for removal of system 200. Removal enables maintenance, upkeep or applying the level wind system 200 to another winch W. In other embodiments, system 200 is mounted directly to the winch W without separate structural flanges.

### Level Wind Attachment Area

At least one of the flanges is reversibly attached to the winch W, to enable removal of system 200 for maintenance and in some embodiments, interchanging guides. For reversible attachment, the flanges 210, 221 can be thought of in two areas: a level wind attachment area 268 and a winch attachment area 270. The level wind attachment area 268 has support member attachment points 272a-d and leadscrew linker attachment points 274 (e.g., bolts holes for bolts). The leadscrew linker 276 is a physical piece designed to place the leadscrew 204 at the center point of a hollow support 202, and most often comprises a plate with a leadscrew attachment point 278 in the center that accepts the leadscrew 204, and a plurality of linker attachment points 278A-278D that attach onto corresponding points on the flange.

At least one flange, shown as flange 221 in FIG. 7, accommodates motor 224 with a plurality of motor attachment points 273, one of which can be seen in FIG. 7. Preferably motor attachment points 273 are adapted to fit into other attachment points of a flange; typically support member attachment points 272. Motor attachment points 273 that line up with other attachment points may then use a single fastener (e.g., a bolt) of simply longer length to connect all of the components.

### Winch Attachment Area

The winch attachment area 270 has a plurality of winch attachment points 280a-c from the flange to at least the winch W. In the currently preferred embodiment, at least a portion of connection at the winch attachment points 280a-c can be disconnected, allowing the level wind system 200 to swing, or otherwise move out of a first, operating position to at least a second position. The first position represents the normal location for level wind operation. The second position allows access to the winch assembly from the previously obscured approach. An example of a useful second position is during normal winch assembly movement, moving the level wind system 200 to one side to allow for easy crane attachment to the winch assembly. The winch assembly would provide additional attachment points at the second position to secure the level wind system 200 while it is in that position (i.e., to avoid damage while moving the winch).

In some embodiments a load sensor (in addition to or in place of load sensor 234) is placed through one winch attachment point 280, to measuring load placed onto the system 200. An embodiment with a load sensor placed between the flange and the winch may be duplicative of the load sensor in the guide, or may replace the load sensor in the guide, in other words the guide would not contain a load sensor.

### Motor

The level wind system 200 is actuated by a motive mechanism 224. Most often the motive mechanism, referred for simplicity herein as the motor 224, comprises a direct drive electric motor. The motor 224 may be any motive force, as known in the art suited to apply a force from motor 224 onto leadscrew 204, to actuate leadscrew 204 and move guide 206 across the length of support 202.

In the currently preferred embodiment, motor 224 comprises a separate motor unit from the motor that drives the winch W. Typically, motor 224 and the winch motor have a virtual gear ratio, that is for every turn of the winch drum WD by the winch motor, motor 224 turns leadscrew 204 (and therefore guide 206) a specific distance. As a purely hypothetical example, for every single turn on the winch drum WD, the level wind motor 224 turns ten times, or a 1:10 turn ratio. Thus, controller 264 may command movement of guide 206 according to the turns of the winch drum WD and increase or decrease the amount of movement per winch drum WD turn, to accommodate different tension member TM diameters. For example, when handling 0.322 inch diameter tension member TM, the controller 264 is set to move the guide 0.322 inches for every turn of the winch drum. Likewise, when handling another size of tension member, the guide 206 moves a different distance per drum turn.

### Controller

The present invention provides for a controlling apparatus to control the system 200, referred herein as the controller 264. In the currently preferred embodiment, controller 264 comprises a winch controlling system as known in the art and controls both the winch apparatus and the level wind system 200. The controller 264 is most often connected to motor 224, the winch motor, the metering sensor 260 and the load sensor 234. Connections are most often wired and connected as known in the art. Load sensor 234 and metering sensor 260 are wired most often through support 202, and the wiring is secured onto a shelf 266, as illustrate in FIG. 10B. A wire chain or wire carrier retains the wires and allows them to extend and contract with guide 206 as it moves along support 202, without entangling or becoming ensnared in leadscrew 204, nut 226, shuttle 226, or any other component.

As illustrated in FIG. 13, the present invention further provides the ability to detect when guide 206 reaches the side of the winch drum WD, or at another, specific site of the drum WD. In the currently preferred embodiment, guide 206 further comprises a position sensor 282 to measure distance between guide 206 and either one of the ends of support 202, flange 210, 221, side of the winch drum WD, or a combination thereof. As illustrated in FIG. 13, arrow 284 depicts position sensor 282 sensing the distance between it and flange 221. Alternatively, or in addition to, arrow 286 depicts position sensor 282 determining the distance to the side of the winch drum WD. Position sensor 282 further allows for controller 264 to assign two or more partitions to the winch drum WD. Each partition may be serviced by the system 200 independently of the other. Each drum partition, areas depicted with dash-dotted lines as winch drum partition 288 and drum partition 290 in FIG. 13 will then accept different types or lengths of tension members, and system 200 may wind each partition in turn. An additional, physical drum divider 292 may be added to the winch drum WD to physically separate the partitions. The position sensor 282 may use the drum divider 292 to determine the proper positions for wrapping each section, as depicted by arrow 294. The position sensor 282 may be used without splitting the winch drum WD into partitions, particularly for determining where guide 206 is in space in relation to the winch drum WD. The position sensor 282 may also inform system 200 when to reverse direction of leadscrew 204, and therefore guide 206.

In one example of the present level wind system, is combined with a winch and winch turntable as described in U.S. Patent publications 2028/0244507 and 2026/0267747, respectfully. Such a winching system enables simultaneous unspooling of one tension member TM from one drum partition 288, while a second tension member TM is spooled onto the winch W on a second drum partition 290. The unspooling tension member TM leaves the drum WD, is guided through guide 206 and off the winch W (often through a ship A-frame AF). In this example, the tension member TM is unspooled from the winch off the stern of the ship. On the opposite side (towards the bow), a user or machine spools a second tension member onto the turning drum WD, while the first tension member is played out. Most often the second tension member is applied by hand, but a second level wind system can be used to get a perfect winding on the drum WD. The second level wind would be connected to the same controller 264 as the winch W and level wind system 200, and built onto a separate support member, most often independent of the winch.

It is the intention, therefore, to be limited only as indicated by the scope of the claims appended hereto. Other embodiments will occur to those skilled in the art and are within the following claims.

The aforementioned patent applications US 2028/0244507 (and the PCT application it claims priority to, PCT/US26/45466), US 2026/0267747, WO 02/38487, WO 02/06246 and paper by Mortensen et al. Annals of Glaciology 55(68) 2024, pp.99-204 and any other reference cited herein is each incorporated by reference in their entirety.

What is claimed is:

1. A level wind system for a winch, comprising:
an elongate support;
a leadscrew having a longitudinal axis which defines a first axis;
a guide substantially supported by said support, adapted to (i) move along said support, (ii) receive a tension member, said tension member having a first force and (iii) to transfer said first force to said support;
a motor connected to said leadscrew and adapted to apply a second force onto said leadscrew; and
a shuttle connected said guide and leadscrew, and adapted to move along said leadscrew parallel to said first axis in response to said second force; and
wherein said support is positioned substantially between said leadscrew and said guide.

2. The system of claim 1 wherein said support is substantially hollow; and wherein said leadscrew is interior of said support.

3. The system of claim 2, wherein said support comprises an opening along at least a portion of the support's longitudinal length, wherein said shuttle connects said guide through said opening.

4. The system of claim 2 wherein said support is coaxial with said first axis.

5. The system of claim 4 wherein said guide is coaxial with said first axis.

6. The system of claim 1 wherein said guide is coaxial with said first axis.

7. The system of claim 1 wherein said support has a longitudinal axis, which defines a second axis, and said guide is coaxial with said second axis.

8. The system of claim 1 further comprising a controller and a position sensor, wherein said controller configured to assign at least a first and a second partition to the lateral length of the winch drum.

9. The system of claim 1 wherein the system contains no additional supports.

10. The system of claim 1 wherein said guide comprises a first and a second portion, said first portion being rigidly connected to said shuttle and said second portion is rotatatably connected to said first portion.

11. The system of claim 10 further comprising:
a load sensor, within said first portion; and
a controller connected to said load sensor;
wherein said load sensor measures said first force and directs said measurement to said controller.

12. The system of claim 10, further comprising:
a metering sensor; and
a controller;
wherein said metering sensor measures a rotation rate of said second portion and directs said measurement to said controller.

13. A method of level winding a tension member about a winch, comprising the steps:
(a) selecting a level wind system comprising an elongate support, a leadscrew having a first longitudinal axis, a guide substantially supported by said support, a motor connected to said leadscrew, adapted to apply a first force onto said leadscrew, and a shuttle connected to said guide and said leadscrew, wherein said shuttle is adapted to move along said leadscrew parallel to said first axis in response to said first force;
(b) mounting said level wind system to a winch;
(c) applying a tension member to said guide;
(d) operating said winch to spool said tension member, wherein said tension member applies a second force to said guide and said guide transfers said second force to said support.

14. The method of claim 13 wherein said guide comprises:
a first portion being rigidly connected to said shuttle;
a second portion being rotatatably connected to said first portion; and
a load sensor within said first portion;
wherein said load sensor measures said second force and directs said measurement to an interconnected controller.

15. The method of claim 13 wherein said support has a second longitudinal axis and said guide is coaxial with said second longitudinal axis.

16. The method of claim 13, wherein said support is substantially hollow, and wherein said leadscrew is interior of said support.

17. The method of claim 16 wherein said support is coaxial with said first longitudinal axis.

18. A level wind system for a winch, comprising:
a leadscrew having a longitudinal axis which defines a first axis; and
a guide substantially supported by said leadscrew, adapted to (i) move along said leadscrew, (ii) receive a tension member, said tension member having a first force and (iii) to transfer said first force to said leadscrew; and
wherein said first force drives said guide along said leadscrew parallel to said first axis.

19. The system of claim 18, wherein said guide surrounds said leadscrew and said guide is coaxial with said first axis.

20. The system of claim 18, wherein said guide further comprises a first and a second portion, said second portion being rotatably connected to said first portion.
